(19) United States
(12) Patent Application Publication
(10) Pub. No.: US 2021/0308007 A1
(43) Pub. Date: Oct. 7, 2021

(54) LOCATION GUIDANCE-ENABLED CPR ASSIST DEVICE

(71) Applicant: Keith G. Lurie, Minneapolis, MN (US)

(72) Inventor: Keith G. Lurie, Minneapolis, MN (US)

(21) Appl. No.: 17/222,476

(22) Filed: Apr. 5, 2021

Related U.S. Application Data
(60) Provisional application No. 63/005,901, filed on Apr. 6, 2020.

(51) Int. Cl. A61H 31/00

(52) U.S. Cl. CPC A61H 31/006; A61H 2201/5097; A61H 31/005

(57) ABSTRACT

A portable head up CPR device includes an automated mechanical chest compression-decompression device, a support structure configured to elevate a head and thorax of an individual in a controlled manner, a wireless network interface, and a signaling interface. The device may include at least one processor and a memory. The memory may have instructions thereon that, when executed by the at least one processor, cause the at least one processor to: receive a signal from an EMS dispatch system via the wireless network interface, the signal comprising a location of the individual in distress and generate an alert via the signaling interface. The alert may be selected from a group including an electronic alert, an auditory alert, and a visual alert. The alert may include instructions to move the portable head up CPR device to the location of the individual in response to receiving the signal.

### CROSS-REFERENCE TO RELATED APPLICATIONS

This application claims priority to U.S. Provisional Patent Application No. 63/005,901, filed Apr. 6, 2020, the disclosure of which is incorporated by reference herein in its entirety.

### BACKGROUND OF THE INVENTION

Time is of the essence for a patient in cardiac arrest and restoration of vital organ blood flow is key to survival. Multiple methods and devices exist to improve blood flow to the heart and brain in patients in cardiac arrest and other acute disease states. However, these treatment options are not always delivered to the patient in a timely manner, especially when cardiac arrest occurs outside of a medical facility. Therefore, improvements in the delivery of life-saving resuscitation technologies to a patient in cardiac arrest in a timely manner are desired.

### BRIEF SUMMARY OF THE INVENTION

Embodiments of the present invention are directed to systems and methods for alerting nearby persons to move a head up position (HUP) cardiopulmonary resuscitation (CPR) device to a location of a nearby cardiac arrest patient and operate the HUP CPR device to treat the patient. Embodiments allow an EMS operator or dispatch system to locate a nearest HUP CPR device to a patient and send a signal that activates an alert system of the HUP CPR device. The alert system informs nearby persons that the HUP CPR devices needed and provides electronic, audio and/or visual location guidance and/or operational instructions to a user. The HUP CPR device may also be able to establish a communications link with a medical expert that may help guide the user on how to treat the patient using the HUP CPR device.

In one embodiment, a portable head up CPR device is provided. The device may include an automated chest compression-decompression device. The device may include a support structure configured to elevate a head and thorax of an individual. The device may include a wireless network interface. The device may include a signaling interface. The device may include at least one processor. The device may include a memory. The memory may have instructions thereon that, when executed by the at least one processor, cause the at least one processor to receive a signal from an EMS dispatch system via the wireless network interface. The signal may include a location of the individual in distress. The instructions may further cause the at least one processor to generate an alert via the signaling interface. The alert may be selected from a group that includes an electronic alert, an auditory alert, and a visual alert. The alert may include instructions to move the portable head up CPR device to the location of the individual in response to receiving the signal.

In some embodiments, the instructions, when executed, may further cause the at least one processor to activate a lift mechanism of the portable head up CPR device to move the support structure to elevate the head and thorax of the individual. The device may include at least one sensor that is configured to sense electrical activity for the individual. The device may include a defibrillator that is configured to deliver one or more shocks to the individual based upon the interpretation of the sensed electrical activity. The instructions, when executed, may further cause the at least one processor to: cause the chest compression device to deliver chest compressions to the individual. The alert may include instructions for using the portable head up CPR device to treat the individual. The device may include a communications interface that is configured to establish a communications link between a user of the portable head up CPR device and a remotely located medical expert. The instructions, when executed, may further cause the at least one processor to determine a location of the portable head up CPR device. The instructions, when executed, may further cause the at least one processor to communicate the location of the portable head up CPR device to the EMS dispatch system.

In one embodiment, an emergency dispatch system is provided. The system may include a communications interface. The system may include at least one processor. The system may include a memory. The memory may have instructions stored thereon that, when executed by the at least one processor cause the at least one processor to receive a first signal from an emergency medical system. The first signal may indicate that an individual at a particular location is suffering from cardiac arrest. The instructions may further cause the at least one processor to locate a portable head up CPR device that is most proximate to the particular location. The instructions may further cause the at least one processor to send, using the communications interface, a second signal to the portable head up CPR device. The second signal may cause the portable head up CPR device to produce one or both of an auditory alert and a visual alert that instructs a nearby user to move the portable head up CPR device to the particular location.

In some embodiments, the instructions, when executed, may cause the at least one processor to establish a communications link between the portable head up CPR device and a medical service provider. The communications link may support one or both of telecommunication and visual communication. The second signal may further cause the portable head up CPR device to switch from a low power mode to a normal operational mode. Locating the portable head up CPR device may include comparing the particular location to a database of known locations of portable head up CPR devices. Locating the portable head up CPR device may include receiving a current location of a number of portable head up CPR devices and comparing the particular location to the current locations of the number of portable head up CPR devices. The emergency dispatch system may be remotely located from the emergency medical system. The first signal may be received via the communications interface.

In some embodiments, a method of operating a portable head up CPR device is provided. The method may include receiving, by the portable head up CPR device, a signal from an EMS dispatch system. The signal may include a location of an individual suffering from cardiac arrest. The method may include generating an alert, by the portable head up CPR device. The alert may be selected from a group that includes an electronic alert, an auditory alert, and a visual alert. The alert may include instructions to move the portable head up CPR system to the location of the individual in response to receiving the signal. The method may include moving a support surface of the portable head up CPR device to elevate a head and thorax of an individual. The method may include actuating a chest compression device to perform chest compressions on the individual while the head and the thorax of the individual are elevated.

In some embodiments, the method may include detecting, by the portable head up CPR device, that the portable head up CPR device has been moved from a storage location. The method may include initiating one or both of audio or video instructions that inform a user how to operate the portable head up CPR device upon detecting that the portable head up CPR device has been moved from the storage location. Detecting that the portable head up CPR device has been moved from the storage location may include detecting, using a sensor, that the portable head up CPR device has been disengaged from a mounting mechanism. Detecting that the portable head up CPR device has been moved from the storage location may include detecting movement of the portable head up CPR device using one or more motion sensors. Initiating one or both of audio or video instructions may include establishing a live communications link between the portable head up CPR device and a medical service provider. The method may include switching from a low power mode to a normal operational mode upon receiving the signal.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a set of parentheses containing a second label that distinguishes among the similar components. If only the first reference label is used in the specification, the description is applicable to any one of the similar components having the same first reference label irrespective of the second reference label.

FIG. 1A is a schematic of a patient receiving CPR in a supine configuration according to embodiments.

FIG. 1B is a schematic of a patient receiving CPR in a head and thorax up configuration according to embodiments.

FIG. 2A is a schematic showing a configuration of head up CPR according to embodiments.

FIG. 2B is a schematic showing a configuration of head up CPR according to embodiments.

FIG. 2C is a schematic showing a configuration of head up CPR according to embodiments.

FIG. 3A depicts a HUP CPR device in a lowered position according to embodiments.

FIG. 3B depicts the HUP CPR device of FIG. 3A in an elevated position.

FIG. 3C depicts a locking handle of the HUP CPR device of FIG. 3A.

FIG. 3D depicts the locking handle of the HUP CPR device of FIG. 3A.

FIG. 3E depict a linear actuator of the HUP CPR device of FIG. 3A in an elevated position.

FIG. 3F depict the linear actuator of the HUP CPR device of FIG. 3A in a lowered position.

FIG. 3G depicts the HUP CPR device of FIG. 3A in a lowered position.

FIG. 3H depicts the HUP CPR device of FIG. 3A in an elevated position.

FIG. 3I depicts a latch of the HUP CPR device of FIG. 3A.

FIG. 3J depicts the latch of the HUP CPR device of FIG. 3A.

FIG. 3K depicts a release knob of the HUP CPR device of FIG. 3A.

FIG. 3L depicts a release cable of the HUP CPR device of FIG. 3A.

FIG. 4A illustrates a HUP CPR device in a fully stowed position according to embodiments.

FIG. 4B illustrates the HUP CPR device of FIG. 4A in a partially unpacked position according to embodiments.

FIG. 4C illustrates the HUP CPR device of FIG. 4A in a partially unpacked position according to embodiments.

FIG. 4D illustrates the HUP CPR device of FIG. 4A in a partially unpacked position according to embodiments.

FIG. 4E illustrates the HUP CPR device of FIG. 4A in a fully unpacked position according to embodiments.

FIG. 5 illustrates a HUP CPR device according to embodiments.

FIG. 6 illustrates a system for providing location guidance in a HUP CPR device according to embodiments.

FIG. 7A illustrates an embodiments of a HUP CPR device in a folded position.

FIG. 7B illustrates the HUP CPR device of FIG. 7A in an unfolded position.

FIG. 7C illustrates the HUP CPR device of FIG. 7A supporting a patient in a lowered position.

FIG. 7D illustrates the HUP CPR device of FIG. 7A supporting a patient in an elevated position.

FIG. 8 illustrates a flowchart of a process for operating a portable head up CPR device according to embodiments.

### DETAILED DESCRIPTION OF THE INVENTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

Beginning treatment on cardiac arrest patients as soon as possible is critical to provide the greatest chance of successful resuscitation. A recent discovery that HUP CPR is remarkably effective when delivered within 10 minutes from the 911 call for helps is a driving force behind this invention. While many efforts to resuscitate a patient after cardiac arrest have focused on early defibrillation, it is now clear that improved blood flow to the brain and heart, delivered with the head and thorax in the elevated position, can markedly improve the chances for resuscitation.

After a sudden cardiac arrest (SCA), time to treatment is literally a matter of life or death. Currently, when first responders, usually police or firefighters, arrive to perform Basic Life Support (BLS) they are equipped, at best, with an automated external defibrillator (AED), a trained pair of hands to perform CPR, and a resuscitator bag with a facemask for ventilation. While this approach can help SCA patients, as it provides a way to rapidly defibrillate some patients, it has not been sufficient to move national out-of-hospital neurologically-intact survival rates to even 10% since closed chest CPR was first described in 1960. The age of Covid-19 has led to greater recognition of the importance of crew safety and why automated CPR should be performed to reduce exposure of front line responders. This application is focused on developing a novel, state-of-the art, time-sensitive automated bundle of SCA care notification and delivery system.

Current CPR treatment, largely unchanged for 60 years, is based upon a labor-intensive hard-to-perform technique with a pair of hands. Previously the applicant has discovered, invented, developed and implemented better ways to circulate blood to the heart and brain that increases the likelihood of neurologically-intact survival after SCA. These advances were sorely needed, as conventional (C)-CPR only provides 15-20% of normal blood flow to the heart and brain and only 20-30% of all patients present with a shockable rhythm that can be treated with rapid defibrillation. Even with rapid AED use, the vast majority of patients never wake up. The applicant has taken a suction cup-based manual active compression-decompression (ACD) CPR device used to compress the chest and provide up to 20 lbs of full lift, the ResQPUIMP®, and an impedance threshold device (ITD), the ResQPOD®, from invention into clinical use. [Lurie K G, Nemergut E C, Yannopoulos D, Sweeney M. The Physiology of Cardiopulmonary Resuscitation. Anesth Analg. 2015.] Despite this progress, the dream of a fully automated and optimized resuscitation system that can be rapidly deployed by professional and lay rescuers remains elusive. At present, most widely used mechanical CPR device, the Lund University Cardiac Arrest System (LUCAS 3.1°), lacks the capacity for full active decompression. Co-invented by the applicant, this device represents a step forward but in multiple clinical trials it was only found to be equivalent to manual CPR. LUCAS is limited as it only pulls up with 3 lbs, less force than needed to optimize outcomes. Thus, although these collective efforts have helped, an effective fully automated resuscitation system for SCA remains an enormous unmet need.

More recently the applicant introduced the idea of elevation of the head and thorax during ACD CPR with an ITD. Both of these circulatory-enhancer CPR adjuncts are needed to pump blood “uphill”. This novel approach immediately unclogs the brain of venous blood, lowers intracranial pressure (ICP) that spike with each chest compression, enhances cardiac preload, expands lung volume, and doubles blood flow to the brain when compared with ACD+ITD CPR in the flat position. In a well-accepted animal model this Head Up Position (HUP) bundled approach normalizes cerebral perfusion pressures and results in a 6-fold higher neurologically intact survival rate versus high quality conventional CPR (c-CPR) in the flat position. Based upon these new findings, the first clinical HUP CPR device (EleGARD®) was developed.

Early clinical experience with this Bundle of Care in >400 patients that includes the combination ACD+ITD CPR elevation of the head and thorax in a specific device-assisted controlled manner, herein is called ACD+ITD HUP CPR, resulted in a discovery that time to HUP CPR treatment is of paramount importance. Over 90% of patients with a shockable rhythm could be successfully resuscitated on scene when HUP CPR was started within 10 min from the 911 call, nearly twice the success rate compared with historical controls. Similar benefits were observed in patients with a non-shockable rhythm. [Moore J C, Holley J, Scheppke K A, et al. Faster Time to Elevation of the Head and Thorax During Cardiopulmonary Resuscitation Increases the Likelihood of Return of Spontaneous Circulation After Out of Hospital Cardiac Arrest. Circulation. 2020; Volume 142, Issue 24, 2020; Pages e470-e500(24):e470-e500.] HUP CPR was performed with an EleGARD, an ITD, and a manual ACD CPR device and/or a LUCAS. These novel clinical data provide a need for a technological solution to provide rapid access and expeditious use of an ACD+ITD HUP CPR device to improve outcomes after SCA. Heretofore an optimal device for delivery of this ‘time-is-of-the essence’ essential life-saving task did not yet exist. Moreover, without a means to alert potential rescue personnel in the vicinity of a person in cardiac arrest and bring the ACD+ITD HUP CPR alert and rapid portable delivery system to the patient and initiate treatment, most cardiac arrest patients will continue to die, despite receiving traditional CPR and defibrillation.

Embodiments of the present invention may be directed to CPR devices, and in particular head up (HUP) CPR devices, that may enable an emergency dispatcher or other personnel to remotely activate location-guidance and/or alerting functions that may enable persons (medical or non-medical) to locate the CPR device and patient and begin administering CPR to the patient. In some embodiments, the dispatcher may activate a nearest head up CPR device to the patient, even if the CPR device is not in a same building. This may help ensure that a patient receives proper CPR as quickly as possible, in many cases prior to the arrival of medical first responders. In some embodiments, the CPR devices may provide instructions to users to help the users correctly position the patient on the CPR device and subsequently activate the CPR device. In some embodiments, the CPR devices may include a communications interface that may establish a communications link between a user of the device and a medical professional that is located remotely from the HUP CPR device, such as in a medical facility or emergency dispatch center. The communications link may enable the medical professional to talk the user through the use of the HUP CPR device, to answer any questions from the user, and/or assist with any other issues or complications that may arise.

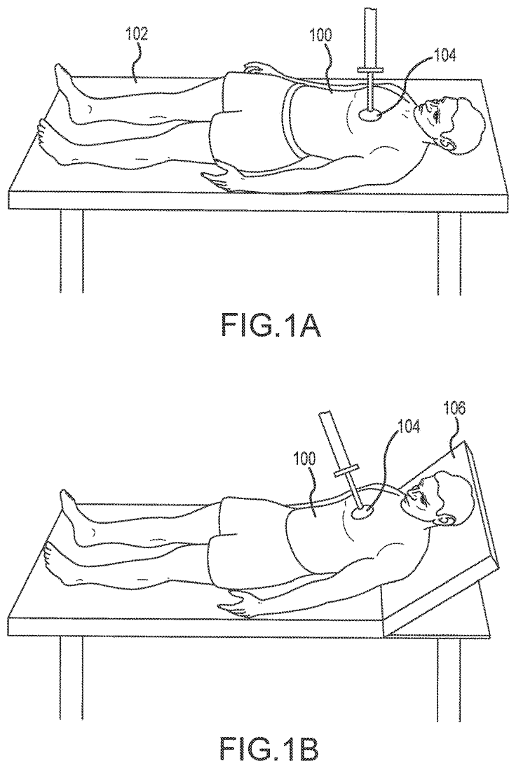

Turning now to FIG. 1A, a demonstration of the standard supine (SUP) CPR technique is shown. Here, a patient 100 is positioned horizontally on a flat or substantially flat surface 102 while CPR is performed. CPR may be performed by hand and/or with the use of an automated CPR device and/or ACD+CPR device 104. In contrast, a head and thorax up (HUP) CPR technique is shown in FIG. 1B. Here, the patient 100 has his head and thorax elevated above the rest of his body, notably the lower body. The elevation may be provided by one or more wedges or angled surfaces 106 placed under the patient's head and/or thorax, which support the upper body of the patient 100 in a position where both the head and thorax are elevated, with the head being elevated above the thorax. HUP CPR may be performed with conventional standard CPR alone, with ACD alone, with the ITD alone, with the ITD in combination with conventional standard CPR alone, and/or with ACD+ITD together. Such methods regulate and better control intrathoracic pressure, causing a greater negative intrathoracic pressure during CPR when compared with conventional manual CPR. In some embodiments, HUP CPR may also be performed in conjunction with extracorporeal membrane oxygenation (ECMO).

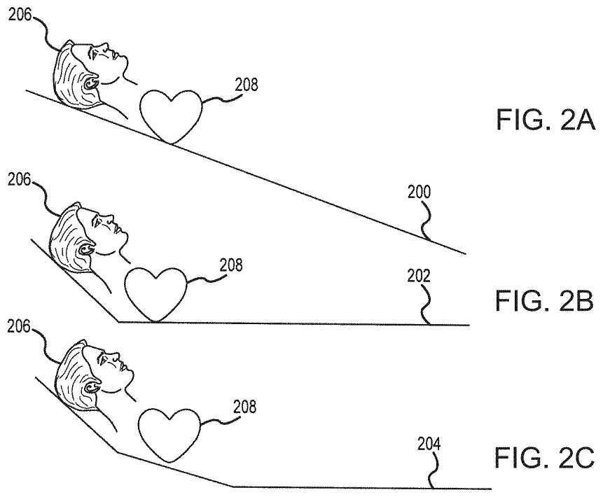

FIGS. 2A-2C demonstrate various set ups for HUP CPR as disclosed herein. Configuration 200 in FIG. 2A shows a user's entire body being elevated upward at a constant angle. As noted above, such a configuration may result in a reduction of coronary and cerebral perfusion during a prolonged resuscitation effort since blood will tend to pool in the abdomen and lower extremities over time due to gravity. This reduces the amount of effective circulating blood volume and as a result blood flow to the heart and brain decrease over the duration of the CPR effort. Thus, configuration 200 is not ideal for administration of CPR over longer periods, such as those approaching average resuscitation effort durations. Configuration 202 in FIG. 2B shows only the patient's head 206 being elevated, with the heart and thorax 208 being substantially horizontal during CPR. Without an elevated thorax 208, however, systolic blood pressures and coronary perfusion pressures are lower as lungs are more congested with blood when the thorax is supine or flat. This, in turn, increases pulmonary vascular resistance and decreases the flow of blood from the right side of the heart to the left side of the heart when compared to CPR in configuration 204. Configuration 204 in FIG. 2C shows both the head 206 and heart/thorax 208 of the patient elevated, with the head 206 being elevated to a greater height than that heart/thorax 208. This results in lower right-atrial pressures while increasing cerebral perfusion pressure, cerebral output, and systolic blood pressure compared to CPR administered to an individual in the supine position, and may also preserve a central blood volume and lower pulmonary vascular resistance.

In some cases, CPR with the head and heart elevated may be performed using any one of a variety of manual or automated conventional CPR devices (e.g. active compression-decompression CPR, load-distributing band, or the like) alone or in combination with any one of a variety of systems for regulating intrathoracic pressure, such as a threshold valve that interfaces with a patient's airway (e.g., an ITD), the combination of an ITD and a Positive End Expiratory Pressure valve (see Voelckel et al “The effects of positive end-expiratory pressure during active compression decompression cardiopulmonary resuscitation with the inspiratory threshold valve.” Anesthesia and Analgesia. 2001 April: 92(4): 967-74, the entire contents of which is hereby incorporated by reference) or a Bousignac tube alone or coupled with an ITD (see U.S. Pat. No. 5,538,002, the entire contents of which is hereby incorporated by reference). In some cases, CPR with the head and heart elevated may also be performed with an intra-aortic balloon occlusion device or system (e.g. REBOA) or extracorporeal membrane oxygenation (ECMO) system to further augment circulation. In some cases, the systems for regulating intrathoracic pressure may be used without any type of chest compression. When CPR is performed with the head and heart elevated, gravity drains venous blood from the brain to the heart, resulting in refilling of the heart after each compression and a substantial decrease in ICP, thereby reducing resistance to forward brain flow. This maneuver also reduces the likelihood of simultaneous high pressure waveform simultaneously compressing the brain during the compression phase. While this may represent a potential significant advance, tilting the entire body upward, or at least the head, shoulders, and heart, has the potential to reduce coronary and cerebral perfusion during a prolonged resuscitation effort since over time gravity will cause the redistribution of blood to the abdomen and lower extremities.

It is known that the average duration of CPR is over 20 minutes for many patients with out-of-hospital cardiac arrest. To prolong the elevation of the cerebral and coronary perfusion pressures sufficiently for longer resuscitation efforts, in some cases, the head may be elevated at between about 10 cm and 30 cm (typically about 20 cm as measured from a center of the brain) while the thorax, specifically the heart and/or lungs, is elevated at between about 3 cm and 8 cm (typically about 10 cm as measured from a center of the heart) relative to a supporting surface and/or the lower body of the individual. Typically, this involves providing a thorax support and a head support that are configured to elevate the respective portions of the body at different angles and/or heights to achieve the desired elevation with the head raised higher than the thorax and the thorax raised higher than the lower body of the individual being treated. Such a configuration may result in lower right-atrial pressures while increasing cerebral perfusion pressure, cerebral output, and systolic blood pressure SBP compared to CPR administered to an individual in the supine position. The configuration may also preserve a central blood volume and lower pulmonary vascular resistance.

The head up devices (HUD) described herein mechanically elevate the thorax and the head, maintain the head and thorax in the correct position for CPR both in head up and supine position. Embodiments may include an expandable and retractable thoracic back plate and a neck support, and may allow an angular position of the thoracic plate to adjust during elevation to enable a compression mechanism (such as a piston) of a CPR assist device to compress the sternum at a consistent position and angle (such as, for example, a right angle) relative to the sternum. Embodiments may provide each of these functions simultaneously, thereby enabling maintenance of the compression point at the anatomically correct place when the patient is flat (supine) or their head and chest are elevated.

In some embodiments, it may be advantageous to carefully control the speed at which a patient is elevated and/or lowered before, during, and/or after CPR. For example, it is advantageous to elevate the head slowly when first starting CPR since the blood flow “uphill” is often barely adequate to provide sufficient blood flow to the head and brain. In other words, it takes time to pump blood uphill with the types of chest compression techniques described herein, so it is advantageous to elevate the patient's upper body slowly to make this uphill pumping easier. In contrast, blood drains rapidly from the head when the patient has no blood pressure and the head and upper body are elevated. As a result, there is a need to lower the head fairly rapidly to prevent blood loss in the brain if CPR is stopped while the head is elevated. Typically, this means that the patient's head and upper body may be elevated at a different rate than it is lowered. For example, the patient's head may be elevated over a period of between about 2 and 30 seconds, and typically between about 5 and 20 seconds. The patient's head may be lowered between about 1 and 10 seconds, and typically between about 1-5 seconds.

The HUP CPR devices described herein may include and/or be used in conjunction with one or more physiological sensors to determine rates and timing of elevation and lowering. For example, the patient on the HUP CPR device may be monitored using an electrocardiogram (ECG). The ECG may detect a regular heart rhythm even if the individual has no palpable pulse. Based on this detection of the regular heart rhythm, it may be determined to stop the performance of chest compressions and to promptly lower the head, heart and shoulders to the horizontal plane. This ensures that when CPR is stopped and it is observed that there is a regular heart rhythm but there is an absence of a palpable pulse (a condition termed pulseless electrical activity), the head, heart, and shoulders are rapidly lowered so that excessive blood does not drain from the brain while attempting to lower the patient. In other words, although the patient may now have a stable or regular heart rhythm so that CPR could potentially be stopped, the patient's heart is not strong enough to keep pumping blood “uphill”. In such instances, the patient may be quickly lowered so that the blood in the brain does not immediately drain. It will be appreciated that other sensors [e.g. blood pressure, end tidal CO₂, cerebral oximetry and flow, etc.] may be used in conjunction with the HUP CPR device to determine: when to start and/or stop CPR, when to elevate and/or lower a patient's upper body, a degree of elevation of the patient's upper body, a rate of elevation or lowering of the patient's upper body, and/or other parameters of CPR and/or ITPR. In some cases one or more sensor data will be combined to help determine the best elevation height on a real time basis. For example, sensor data from the regional cerebral oximetry may be used by itself or combined with data from the end tidal CO₂ sensor to optimal brain circulation and oxygenation during CPR and after a successful resuscitation during the recovery period.

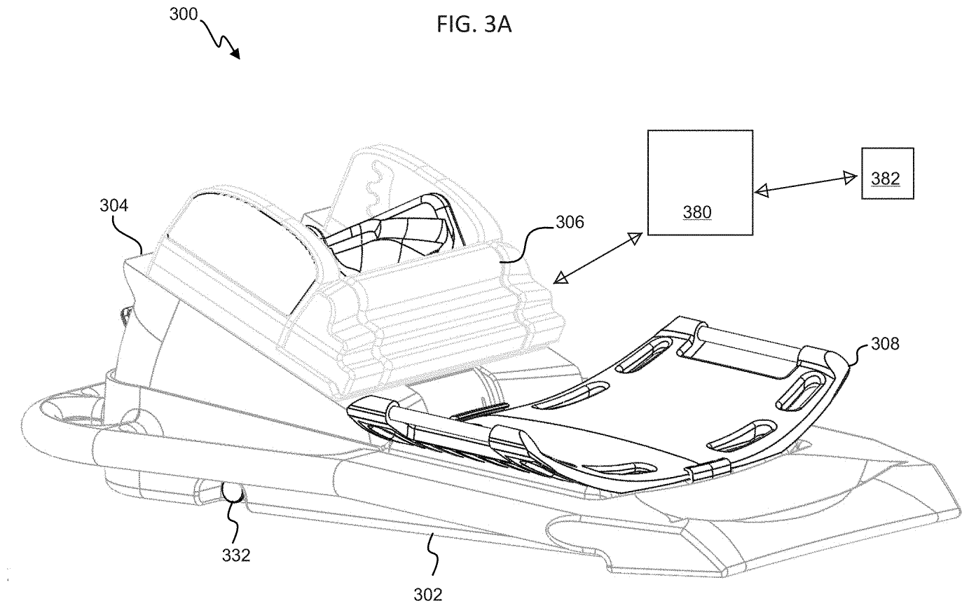

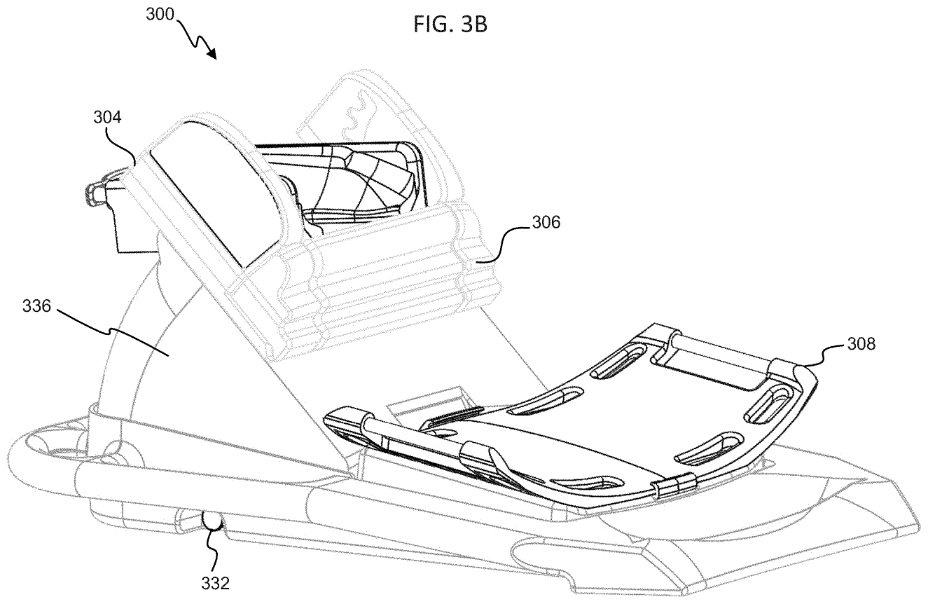

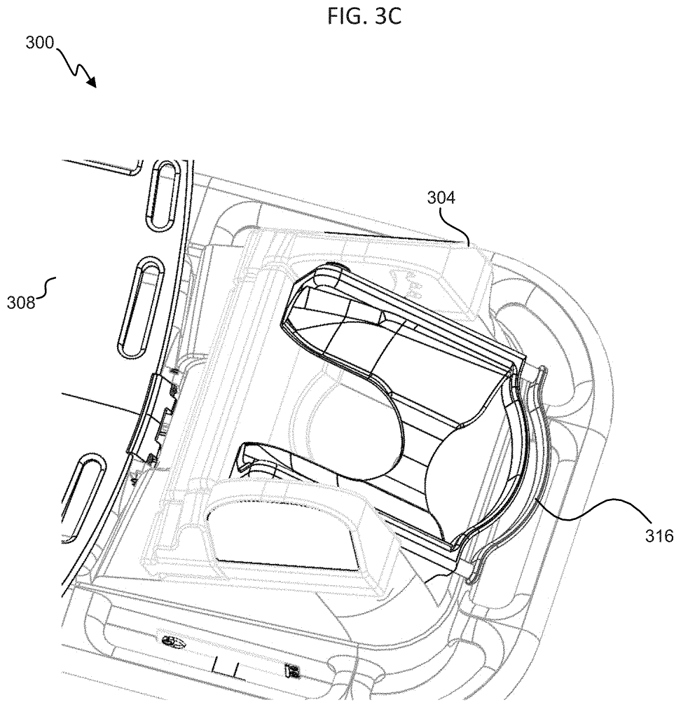

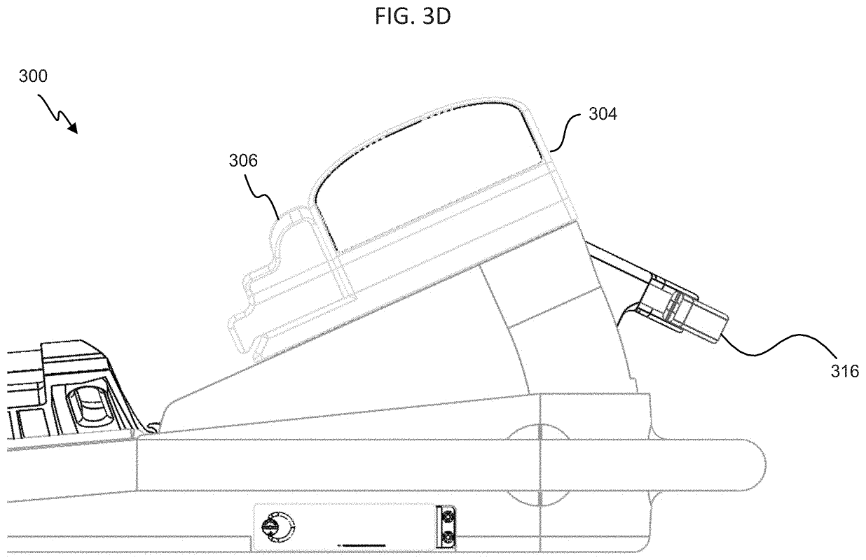

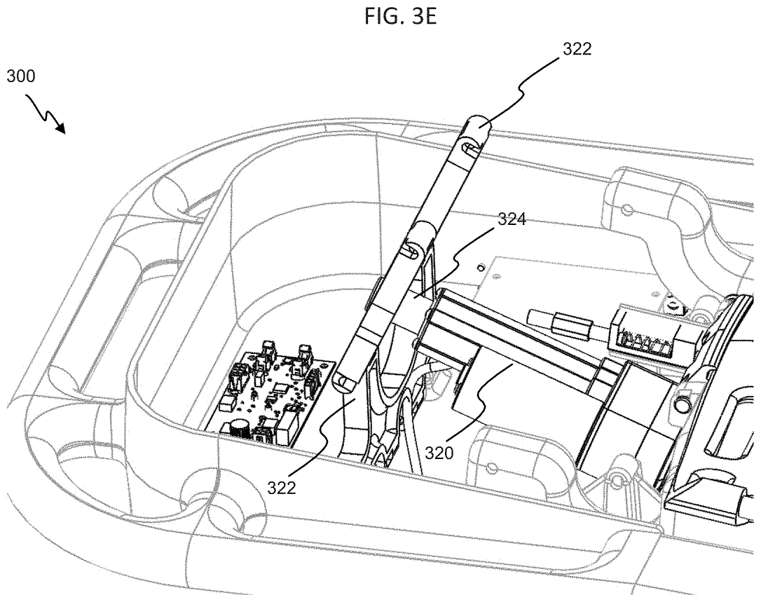

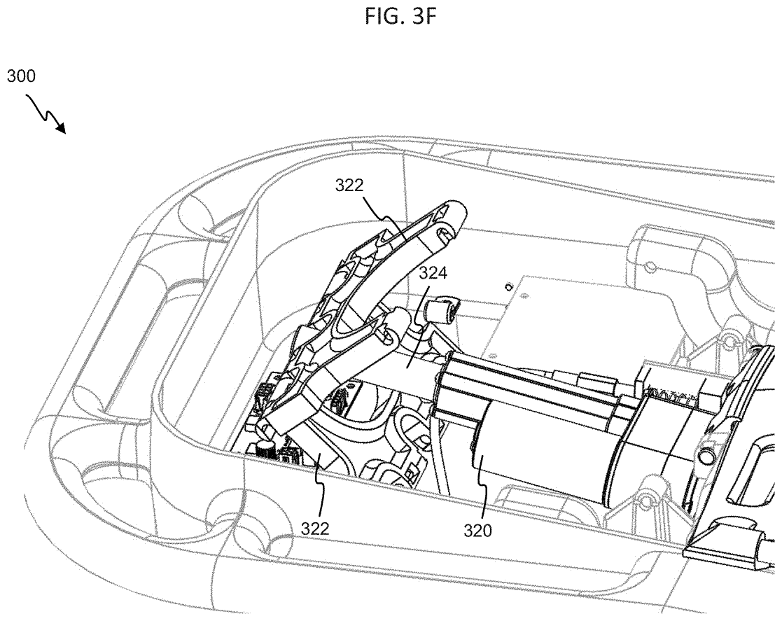

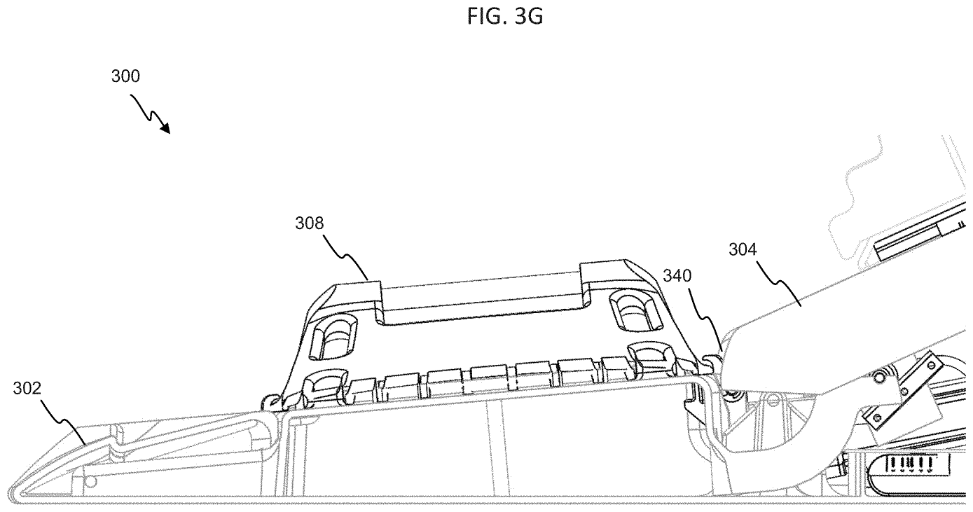

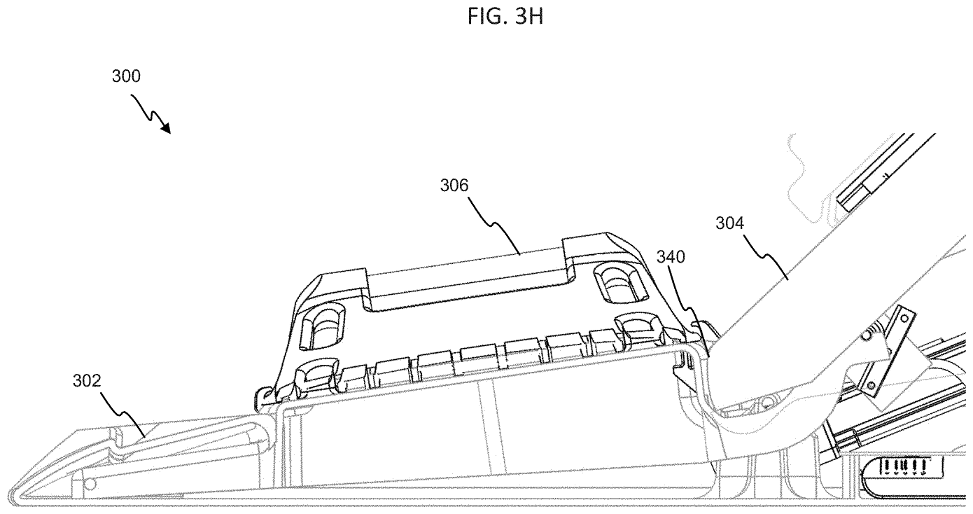

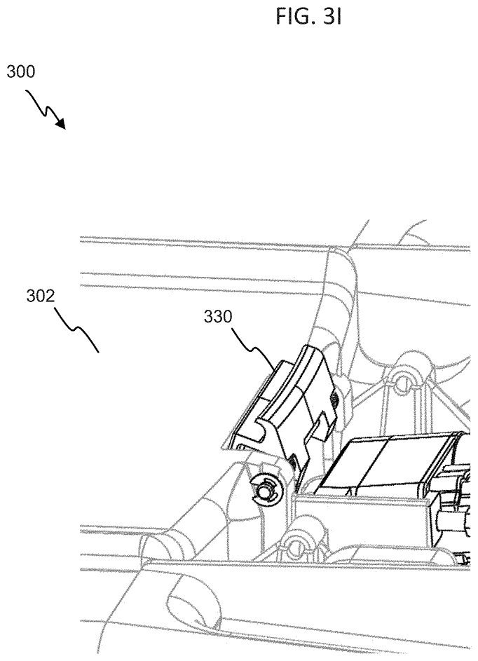

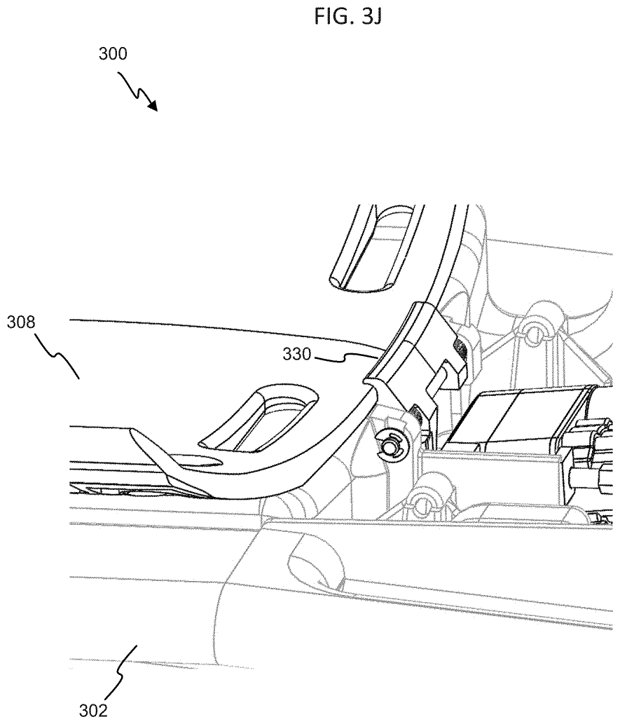

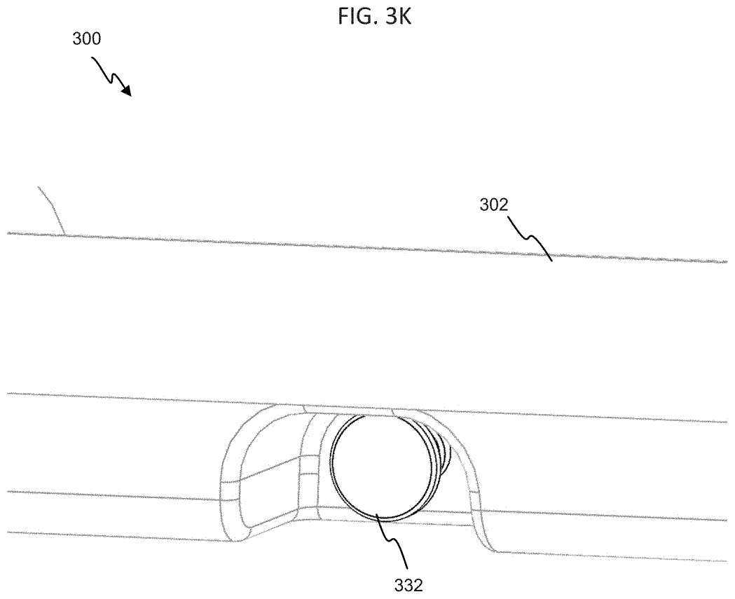

FIGS. 3A-3L depict an example of a HUP CPR device 300, which may be similar to other HUP CPR devices described herein. HUP CPR device 300 is designed to be placed under the patient, for example, as soon as a cardiac arrest is diagnosed. HUP CPR device 300 has a low profile designed to slip under the patient's body rapidly and easily. For example, FIG. 3A shows that HUP CPR device 300 may include a base 302 that includes a support structure that may be used to elevate a patient's thorax and head. For example, the support structure may include a back plate or first support surface 308 and an upper support or second support surface 304. The second support surface 304 may be pivotally or otherwise movably coupled with base 302. Second support surface 304 may include a neck pad or neck support 306, as well as areas that are predefined to receive a patient's upper back, shoulders, neck, and/or head.

An individual may be positioned on the HUP CPR device 300 with his neck positioned on the neck support 306. In some embodiments, the neck support 306 may contact the individual's spine at a location near the C7 and C8 vertebrae. This position may help maintain the individual in the sniffing position, to help enable optimum ventilation of the individual. In some embodiments, the individual may be aligned on the HUP CPR device 300 by positioning his nipples just above a center line of the first support surface 308. A chest compression device (not shown) may be coupled with one or more mounting supports of the first support surface 308 such that a compression mechanism (such as a plunger) of the chest compression device is maintained in alignment with the individual's sternum at a generally orthogonal angle to ensure that the chest compressions are delivered at a proper angle and with proper force. In some embodiments, the alignment of the chest compression device may be achieved by configuring the chest compression device to pivot and/or otherwise adjust angularly to align the chest compression device at an angle substantially orthogonal to the sternum. In some embodiments, the second support surface 304 may define an opening that may receive a portion of a patient's head. This opening may help maintain the patient in the sniffing position for optimal airway management. Oftentimes, a head support may be included on the second support surface 304. The head support may extend around a portion of the opening to support at least a portion of the sides and/or top of the head. The head support may extend around all or a portion of the opening. In some embodiments, the head support may be lowered and/or raised to adjust the position of the patient's head and/or to enable the HUP CPR device 300 to be usable with patients of different sizes and flexibility levels. For example, the head support may be inflatable and/or be expandable using one or more internal supports. To lower the head support, air or another fluid may be removed from a bladder of the head support. In embodiments with internal supports, such as support arms that form the profile of the head support, the internal supports may be retracted at least partially within the second support surface 304 to lower the head support. The head support may be raised by pumping air or another fluid into a bladder of the head support, causing the head support to expand. In other embodiments, the head support may be raised by extending one or more internal supports out of the second support surface 304 and into and interior of the head support. It will be appreciated that other mechanisms may be used to raise and/or lower a head support.

As shown in FIG. 3A, HUP CPR device 300 is in a lowered position, with the second support surface 304 being configured to maintain the patient's head at a position that is slightly elevated relative to the heart, which is supported by first support surface 308. In the lowered position, a head-receiving portion of the second support surface 304 (which is designed to maintain the patient in the sniffing position and extends downward from a top surface of the second support surface 304) maintains the base of the head at a generally horizontal level (within about 5 degrees) when in a fully lowered position. The second support surface 304 may be raised as shown in FIG. 3B to elevate the patient's head, shoulders, and/or heart, which the head being supported at heights of between about 5 cm and 45 cm relative to a horizontal support surface on which the base 302 is supported. Second support surface 304 may be configured to be adjustable such that the second support surface 304 may slide along a longitudinal axis of base 302 to accommodate patients of different sizes as well as to accommodate movement of a patient associated with the elevation of the head by second support surface 304. Without such sliding ability, a patient's upper body has a tendency to curl forward on the HUP CPR device 300 as the patient's upper body is elevated. As shown in FIG. 3B, the second support surface 304, including neck support 306, are extended away from the first support surface 308 when the second support surface 304 is elevated. In some embodiments, this sliding movement may be locked once an individual is positioned on the elevated second support surface 304. In some embodiments, the second support surface 304 may include one or more springs that may bias the second support surface 304 toward the torso. This allows the second support surface 304 to slide in a controlled manner when the individual's body shifts during the elevation process. In some embodiments, the one or more springs may have a total spring force of between about 10 lb. and about 50 lbs., more commonly between about 25 lb. and about 30 lb. Such force allows the second support surface 304 to maintain a proper position, yet can provide some give as the head and upper torso are elevated. Further, the HUP CPR device may include a slide mechanism such that with elevation of the head and neck the portion of HUP CPR device behind the head and shoulder elongates. For example, the slide mechanism may include roller bearings that are mounted on a track that allows the second support surface 304 to slide to accommodate patients of different sizes as well as to handle shifting of the body during elevation, which helps to maintain the neck in the sniffing position. In some embodiments, such as those shown in FIGS. 3C and 3D, a locking handle 316 is provided that allows medical personnel to adjust a lateral position of the second support surface 304 relative to the base 302. To actuate the handle 316, a user must apply force to push a distal portion of the handle 316 toward a fixed, proximal portion of the handle 316. This action pushes a locking member (not shown) into a free space of a ratchet mechanism, allowing the user to adjust the lateral position of the second support surface 304. Once released, the locking member may enter a tooth of the ratchet to set a position of the second support surface 304 based on a size of the user. The second support surface 304 may then only slide in small amounts to handle the shifting of the patient throughout the elevation process.

FIGS. 3E and 3F depict a linear actuator 320 that is used to raise and lower the second support surface 304. Linear actuator 320 is coupled at a joint formed between two or more support members 322. Support members 322 are coupled between the base 302 and a bottom surface of the second support surface 304 such that top support member(s) 322 is coupled with the second support surface 304 and the bottom support member(s) 322 is coupled with the base 302. As linear actuator 320 is operated, a rod 324 of the linear actuator 320 shortens to draw the joint of the support members 322 toward the first support surface 308, which causes an angled between the top and bottom supper members 322 to increase, such as shown in FIG. 3E, forcing the second support surface 304 upward to elevate a patient's upper body. When operated in reverse, the rod 324 of linear actuator 320 extends, pushing on the joint to decrease the angle between the top and bottom support members 322 as shown in FIG. 3F, thereby lowering the second support surface 304. It will be appreciated that the direction of operation of the linear actuator 320 and support members 322 may be reversed in some embodiments such that lengthening rod 324 causes elevation of the second support surface 304 and shortening of rod 324 causes the lowering of the second support surface 304. While shown here with a linear actuator 320 and support member 322, it will be appreciated that HUP CPR device 300 may additionally or alternatively include other lift mechanisms, such as manual lift mechanisms, threaded rods, lead screws, pneumatic and/or hydraulic actuators, motor driven telescopic rods, other lift mechanisms, and/or combinations thereof. Examples of lift mechanisms and/or support devices may be found in U.S. application Ser. Nos. 16/201,339, 16/058,851, 15/160,492, U.S. Pat. Nos. 10,667,987, 10,406,069, 10,406,068, 10,350,137, 9,801,782, 9,750,661, 9,707,152, 10,092,481, and 10,245,209, the entire contents of which are hereby incorporated by reference. The lift mechanisms may adjust the height and/or angle of the second support surface 304 (and, in some embodiments, the first support surface 308) through a range of different elevation positions, including a lowermost and/or supine position, an uppermost position, and/or any number of intermediate elevation positions, which may be defined in terms of angular and/or distance measurements.

Turning back to FIGS. 3A and 3B, the first support surface 308 may be sized and shaped to receive a portion of the patient's back, just behind the heart and may be configured to couple with a chest compression device (not shown). Examples of CPR assist devices that could be used with the HUP CPR device (either in the current state or a modified state) include the Lucas device, sold by Physio-Control, Inc. and described in U.S. Pat. No. 7,569,021, the entire contents of which is hereby incorporated by reference, the Defibtech Lifeline ARM—Hands-Free CPR Device, sold by Defibtech, the Thumper mechanical CPR device, sold by Michigan Instruments, automated CPR devices by Zoll, such as the AutoPulse, as also described in U.S. Pat. No. 7,056,296, the entire contents of which is hereby incorporated by reference, the Weil Mini Chest Compressor Device, such as described in U.S. Pat. No. 7,060,041 (Weil Institute), and the like. Chest compression devices used in accordance with the present invention may be configured to compress and/or actively decompress the chest.

In some embodiments, the first support surface 308 may have a curved profile that may provide some flexibility to the first support surface 308. This flexibility helps when the HUP CPR device 300 is used in conjunction with a chest compression device, as the flexibility ensures that the right amount force applied to the patient's chest. For example, a central portion of the first support surface 308 may flex in the presence of excessive force, thereby absorbing some of the force. For example, as a plunger of a chest compression device is pressed into the patient's chest, some force is transmitted through the patient to the first support surface 308. The first support surface 308 may be configured to bend away from the patient if this transferred force exceeds a threshold. This allows for the delivery of compression at the appropriate depth for patients with differing chest wall sizes and stiffness's. This helps prevent broken ribs and/or other injuries to the patient caused by too much force being applied to the patient's chest, as the flexing first support surface 308, rather than the ribs or other body structures, absorbs a significant portion of the excess force. Such a design is particularly useful when the HUP CPR device is used in conjunction with a chest compression device such as the Lucas device, sold by Physio-Control, Inc. and/or the Zoll AutoPulse.

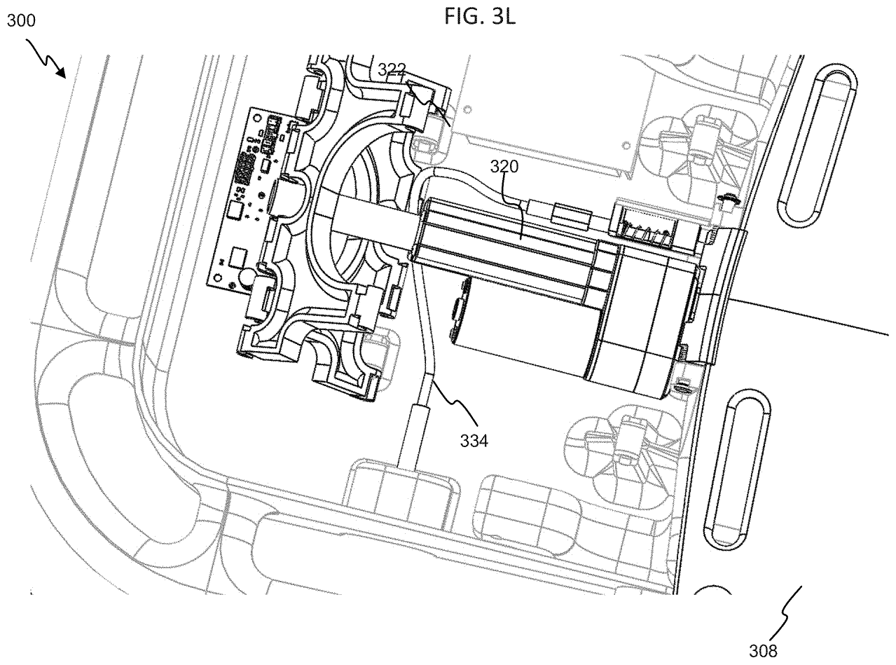

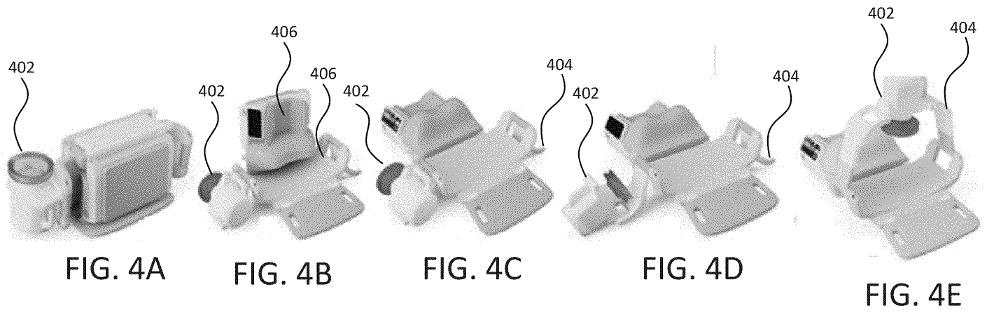

In some embodiments, the first support surface 308 that is part of and/or is coupled with the second support surface 304 in such a manner that an angle of the first support surface 308 is adjustable relative to the base 302 and/or the second support surface 304. The first support surface 308 may be configured to adjust angularly to help combat thoracic shift to help maintain a chest compression device at a generally orthogonal to the sternum. The adjustment of the first support surface 308 may create a separate elevation plane for the heart, with the head being elevated at a greater angle using the second support surface 304 as shown in FIG. 3B. In some embodiments, the first support surface 308 may be adjusted independently, while in other embodiments, adjustment of the first support surface 308 is tied to the elevation of the second support surface 304. For example, a first support surface may include a roller (such as a v-groove bearing) positioned on an elevation track formed on or coupled with an underside of an second support surface as illustrated in the embodiment discussed in relation to FIGS. 4G-4J of U.S. patent application Ser. No. 15/850,827, previously incorporated by reference. The roller may be positioned on a forward, raised portion of the elevation track. As the second support surface 304 is elevated, the roller is forced upward by elevation track, thereby forcing an end of the first support surface 308 proximate to the second support surface 304 upwards. This causes the first support surface 308 to tilt, thus maintaining the chest at a generally orthogonal angle relative to the chest compression device that is coupled with the first support surface 308. Oftentimes, elevation track may be slanted from a raised portion proximate to the first support surface 308 to a lowered portion. The elevation track may be tilted between about 4° and 20° to provide a measured amount of tilt relative to the thoracic shift expected based on a particular elevation level of the second support surface 304. Typically, the first support surface 308 will be tilted at a lower angle than the second support surface 304 is inclined. Such simultaneous movement is also demonstrated in FIGS. 3G and 3H. In FIG. 3G, the second support surface 304 is in the lowered position and the first support surface 308 is in its original position. In FIG. 3H, the second support surface 304 is elevated, which has caused the first support surface 308 to have a corresponding forward tilt, which is less that than the degree of elevation of the second support surface 304.

In some embodiments, the first support surface 308 may be removably coupled with the base 302 and/or the second support surface 304. As shown in FIG. 3I, a latch 330 is provided beneath the first support surface 308. The latch 330 may be spring biased such that a bottom surface of the latch 330 is able to receive a back edge of the first support surface 308. The latch 330 may be pushed downward with the first support surface 308 secured by a tip of the latch 330 until a spring-biased pin (not shown) slides along a bottom surface of the latch 330 and engages with a hole formed within a body of the latch 330. The pin secures the latch 330 in a locked position in which the first support surface 308 is securely coupled with the base 302 and/or second support surface as shown in FIG. 3J. A release knob 332 shown in FIG. 3K is coupled with the base 302 and may be used to draw the pin out of the hole formed in the body of latch 330 to release the first support surface 308. For example, as shown in FIG. 3L, release knob 332 may be coupled to the pin via a flexible cable 334, similar to a brake cable on a bicycle. When knob 332 is pulled, the pin is drawn out of the hole and the spring force can push the latch 330 into a release position in which the first support surface 308 may be removed from the base 302.

In some embodiments, the HUP CPR device 300 may include a number of features that make the device more safe to operate. For example, as seen in FIG. 3A, HUP CPR device 300 may include a vinyl (or other natural or synthetic material) cover 336 that may cover the moving components, such as the motor or actuator and/or slide mechanism. the cover 336 can extend and retract as the second support surface 304 raises and lowers. For example, cover 336 may operate in a manner similar to a convertible top for an automobile, and may retract in a compact, accordion style manner when the second support surface 304 is lowered. The second support surface 304 of HUP CPR device 300 may have a front surface 340 that is curved in a manner such that as the second support surface 304 raises and lowers the front surface 340 stays approximately the same distance from the first support surface 308. In other words, a gap between the two components remains generally constant, which eliminates any possible pinching hazard that could exist due to the relative movement between the two components.

In one embodiment, a controller and/or control system may adjust an actuation speed of a motor or other lift mechanism to raise or lower the second support surface 304 of the HUP CPR device 300 within the necessary time frame. For example, medical personnel may set a desired elevation time (such as between 2 and 30 seconds), starting elevation angle, intermediate elevation angle(s), final elevation angle, rate of elevation, etc. The controller will then operate linear actuator 320, a motor, and/or other lift mechanism to slowly raise the second support surface 304 from a starting elevation angle to a final elevation angle over the selected time period, in one or more sequences. For example, the controller may be configured to elevate the head and thorax may be done in a sequence by 1) elevating the head and thorax over two or more sequential elevation steps and/or 2) elevating the head and thorax over a more prolonged period of time from the start of the elevation to the final height. In some embodiments, the controller may cause the chest compression device to perform CPR for a period of time (between about 30 seconds and 10 minutes, more commonly between about 2 minutes and 8 minutes, and more commonly between about 3 minutes and 6 minutes) while the individual is in a flat, supine position (or nearly supine, such as with the head and/or heart elevated slightly to an angle of less than about 5 degrees relative to horizontal) prior to causing the actuator to elevate the second support surface 304 and the individual to an intermediate and/or final height. In some embodiments where the individual has been primed flat, the controller may perform an additional priming step at an intermediate elevation position prior to elevating the individual to the final/highest elevation position. In other embodiments, the individual may be primed by first elevating the individual's head and heart to one or more intermediate elevation positions (i.e. between about 10 and 25 degrees) and then performing chest compressions for a period of time prior to elevating the individual's heart and head to a final elevation position (i.e. between 20 and 45 degrees). The chest compressions may be continued during the elevation adjustment periods after each priming step.

The controller may also control the rate of elevation of the second support surface 304. As just one example, the controller may maintain the elevation speed at a rate of not faster than 1° over each 3 second period. The lift speed may be linear and/or non-linear throughout each elevation step.

Blood drains rapidly from the head when the patient has no blood pressure and the head and upper body are elevated. As a result, there is a need to lower the head fairly rapidly to prevent blood loss in the brain if CPR is stopped while the head is elevated. Typically, this means that the patient's head and upper body may be elevated at a different rate than it is lowered. The patient's head may be lowered by the controller between about 1 and 10 seconds, and typically between about 2-8 seconds.

The controller may also be configured to cause the actuator to slowly and continuously raise the second support surface 304 (and individual's heart, shoulders, and head) from a starting elevation position to a final elevation position. For example, a starting elevation position may include the individual being positioned in a generally flat, supine position (with the head elevated less than 5° relative to horizontal). The individual's head, shoulders, and heart may be slowly raised (linearly and/or non-linearly) from the starting elevation position to a position where the head is elevated between about 20 and 45 degrees relative to horizontal (an absolute elevation of the heart by about 5-10 cm and an absolute elevation of the head by about 15-25 cm, although these ranges may vary based on the age, size, and/or physiology of a specific individual) over a period of between about 30 seconds and 10 minutes, more commonly between 1 minutes and 4 minutes, and optimally between about 1 minutes and 1 minutes, while CPR is performed. For example, the head, shoulders, and heart may be raised at a rate of between about 2.25°/second and about 1.5°/minute. In other embodiments, an individual may be quickly raised to a starting elevation position of between about 8-15 degrees before slowly elevating the head, shoulders, and heart to a final elevation positon over a period of between about 30 seconds and 10 minutes, more commonly between 2 minutes and 8 minutes, and optimally between about 3 minutes and 6 minutes, while CPR is performed.

In some embodiments, the controller may receive data from one or more physiological sensors and use this data to determine rates and timing of elevation and lowering. For example, the patient on the HUP CPR device 300 may be monitored using an electrocardiogram (ECG). The ECG may detect a stable heart rhythm even if the individual has no palpable pulse. Based on this detection of the stable heart rhythm, it may be determined to stop the performance of chest compressions and to promptly lower the second support surface 304. For example, once it is detected that the patient has a stable heart rhythm, the controller may alert medical personnel that chest compressions should be ceased, and may send a signal to the motor or other actuator to cause the second support surface 304 to rapidly lower. In some embodiments, alerting medical personnel may involve producing a visual indicator, such as lighting up a light emitting diode (LED) or other light source and/or presenting a textual and/or image-based display on a screen of the HUP CPR device 300. In one embodiment, upon detecting a stable heart rhythm, the controller may send a command to the automatic chest compression device that causes the chest compression device to stop the delivery of chest compressions and/or decompressions. In another embodiment, upon detecting the stable heart rhythm, the controller will alert medical personnel, who may then operate the HUP CPR device 300 to lower the second support surface 304. It will be appreciated that other sensors may be used in conjunction with the HUP CPR device 300 to determine: when to start and/or stop CPR, when to elevate and/or lower a patient's upper body, a degree of elevation of the patient's upper body, a rate of elevation or lowering of the patient's upper body, and/or other parameters of CPR and/or ITPR.

The HUP CPR device 300 elevates the head above the heart, with the level of elevation optionally varying depending upon the method of CPR. Conventional closed chest manual CPR itself is inherently inefficient, providing only about 20% of normal blood flow to the heart and brain. Elevation of the head is not safe during conventional CPR as it is not possible to consistently or safely push enough blood “uphill” to the head to take advantage of the effects of gravity of the venous side of the arterial-venous circuit that is integral to cerebral perfusion. Methods of CPR that generate the most forward flow provide the opportunity to elevate the head above the heart more than those methods that provide less forward flow. For example, active compression decompression (ACD) CPR with an impedance threshold device (ITD) can triple blood flow to the heart and brain compared with conventional manual CPR alone and therefore the head can be elevated higher and still get enough perfusion to take advantage of the effects of gravity with HUP CPR. By contrast, the head should not be elevated as much with conventional CPR and the ITD as forward blood flow without ACD CPR is less, and therefore too much elevation of the head could worsen outcomes. For these reasons the optimal head elevation may vary both depending upon the method of CPR used and the condition of the patient.

The relative vertical distance between the head and the heart is important as the amount of pressure needed to “lift” or pump the blood from the heart to the brain is related to this distance. Further, the vertical distance between the head and the heart affects the amount of cerebral perfusion. Although the amount of elevation of the head relative to the heart may vary depending upon the method of CPR (which is the mechanism used to pump the blood), it is generally preferred to have the head elevated relative to the heart by a distance in the range from about 2 cm to about 42 cm. In the specific case where ACD-CPR is being performed with an ITD, the distance may be in the range from about 5 cm to about 25 cm, for standard CPR with an ITD between about 5 cm and about 20 cm, for ACD CPR by itself between about 5 cm and about 20 cm, and with conventional or standard CPR between about 3 cm and about 15 cm. Further, the distance that the heart may be elevated relative to a support surface upon which the lower portion of the patient is resting (such as a table, floor, gurney, stretcher, or the ground) may be in the range from about 3 cm to about 20 cm (with ranges between about 4 cm and 10 cm being common), while the height of the head relative to the support surface may be in the range from about 5 cm to about 45 cm (with ranges between about 10 cm and 40 cm being common). When performing ACD-CPR+ITD, the distance that the heart may be elevated relative to a support surface upon which the patient is resting may be in the range from about 3 cm to about 20 cm, while the height of the head relative to the support surface may be in the range from about 5 cm to about 45 cm. Of course, these relative heights can also be thought of in terms of an angle of elevation of the upper body relative to the lower body when the patient is bent at the waist when performing CPR. Such angles are described herein. Typically, the angle between the patient's heart and brain is between 10 degrees and 40 degrees relative to horizontal to achieve the necessary elevation, although it will be appreciated that such angles are largely driven by the patient's physiology (height, distance between head and heart, etc.).

A ventilation device 380 may be included with the HUP CPR device 300. Ventilation device 380 may be built into the HUP CPR device 300, coupled with the HUP CPR device 300, and/or may be a standalone device that may be used in conjunction with the HUP CPR device 300 when performing split-phase CPR in a head up position. The ventilation device 380 may be any automated and/or manual device that may be interfaced with a patient's airway and that can deliver a positive pressure breath to the airways in a controlled manner. The ventilation device 380 is coupled with one or more sensors 382 that are used by the ventilation device to detect the compression and/or decompression phases of CPR such that the ventilation device 380 delivers positive pressure breaths to the individual at specific times during the CPR procedure. For example, the ventilation device 380 may be configured to deliver positive pressure breaths only (or primarily) during the decompression phases of CPR, whether active or passive decompression is being utilized. The ventilation device 380 may deliver the positive pressure breaths until the sensor(s) detect a compression phase of CPR. This may be done using any number of sensors 382, such as intrathoracic pressure sensors, pressure and/or force sensors attached to the chest electrical impedance sensors, pressure and/or force sensors attached to some part of the patient's body or to the chest compression device, force, flow, and/or pressure transducers in a device attached to the airway such as an endotracheal tube or impedance threshold device, or an active intrathoracic pressure regulator device, and/or timing sensors.

The ventilation device 380 may use the sensor data to control the timing of delivery of positive pressure ventilations. For example, during each decompression phase, a positive pressure breath can be delivered until the compression phase is sensed. The positive pressure ventilation delivery is then halted until the start of the next decompression phase, at which point the ventilation device completes the delivery of the breath and/or starts delivery of a new breath. The duration of the breath supplied by the ventilation device 380 during the decompression phase can be regulated depending on the physiological needs of the patient but in general the breath would be delivered over about 0.75 to 2.0 seconds with all or part of the breath delivered before each compression and any remaining part of the breath delivered after the compression phase.

In some cases, rather than the entire positive pressure breath being delivered during the decompressions phase, a majority of the positive pressure breath is delivered during the decompression phase with the remaining breath extending into a portion of the compression phase. For example, between about 70-90% (oftentimes about 80%) of each breath may be delivered by the ventilation device 380 during the decompressions phase while between about 10-30% (oftentimes about 20%) may be delivered during a subsequent compression phase. This may depend upon a sensed physiological measurement, for example, the intrathoracic pressure or airway pressure. Additionally, in some embodiments, a single positive pressure breath may be delivered across multiple decompression phases and/or compression phases.

In some embodiments the heart will not be elevated. For example, a small head-only HUP CPR device may be used that would only elevate the head, while allowing the heart to remain in the horizontal plane along with the lower body. Such HUP CPR devices may be particular useful when performing CPR without the use of a CPR assist device/automated chest compression device as it reduces the amount of force needed to pump blood to the patient's brain during CPR. In such cases, the head would be raised to a distance in the range from about 5 to 20 cm relative to the heart (which is not elevated relative to the support surface).

In some embodiments, the controller be configured to detect a type of CPR being delivered and may automatically adjust an elevation of the heart and/or head based on the detected level of force. This may be done, for example, by allowing a user to input a type of CPR being performed into the HUP CPR device 300. In other embodiments, such as those where a chest compression device is coupled with or formed integrally with the HUP CPR device, the HUP CPR device may communicate with the chest compression device to determine if the chest compression device is being used to deliver compressions and/or an amount of force being delivered and may make any necessary elevation adjustments based on this data. In other embodiments, one or more physiological sensors may be used to detect physiological parameters, such as cerebral perfusion pressure, intrathoracic pressure, and the like. This sensor data may be used to determine a compression force and/or otherwise determine how high to elevate the head and heart.

In some embodiments, the controller system may be used to control the timing of the delivery of positive pressure breaths by the ventilation device 380. For example, the controller system may receive data from the chest compression device, one or more physiological sensors, and/or timing sensors to ensure that the ventilation device 380 and chest compression device operate synchronously with one another to deliver positive pressure breaths solely or primarily during the decompression phase of CPR in accordance with the present invention. In other embodiments, the ventilation device 380 may have its own dedicated controller system that may take in external data from one or more sources and/or sensors 382 (the chest compression device, one or more physiological sensors, and/or timing sensors) to control the timing of the delivery of positive pressure breaths to the patient.

As one example, the lower body may define a substantially horizontal plane. A first angled plane may be defined by a line formed from the patient's chest 304 (heart and lungs) to his shoulder blades. A second angled plane may be defined by a line from the shoulder blades to the head. The first plane may be angled about between 5° and 15° above the substantially horizontal plane and the second plane may be at an angle of between about 15° and 45° above the substantially horizontal plane. In some embodiments, the first angled plane may be elevated such that the heart is at a height of about 4-8 cm above the horizontal plane and the head is at a height of about 10-30 cm above the horizontal plane.

In some embodiments, the motor and a power supply, such as a battery, will be positioned in a portion of base 302 that is lateral or superior to the location of the patient's heart, such that they do not interfere with fluoroscopic, x-ray, or other imaging of the patient's heart during cardiac catheterization procedures. Further, the base 302 could include an electrode, attached to the portion of the device immediately behind the heart (not shown), which could be used as a cathode or anode to help monitor the patient's heart rhythm and be used to help defibrillate or pace the patient. As such, base 302 could be used as a ‘HUP CPR device’ which would include additional devices such as monitors and defibrillators (not shown) used in the treatment of patients in cardiac arrest.

In some embodiments, a HUP CPR device 400 may be collapsible for storage, as shown in FIGS. 4A-4E. HUP CPR device 400 may include any of the features described in relation to HUP CPR device 300 above. Designed for optimal clinical care, ease of use, and speed of deployment, the device 400 may collapse into a portable small suitcase-like form. This transformative design may enable the entire system to be folded and stored in a significantly smaller configuration. In a stored position, arms 404 of a mechanical CPR device 402 may be folded down to the sides of the device 400, and head and torso supporting portions of a positioning system 406 may be folded as shown in FIG. 4A. Upon arrival to the scene of a SCA, the device 400 may be set down and the head and lower torso portions may be folded out into a treatment position as shown in FIG. 4C. The device 400 may be ready to be deployed under the patient. In a two-person operation, one caregiver may lift the patient by the arms, and the other person may slide the device 400 under the patient, such as by holding the back and side of the device 400 to maneuver the device 400. This may be done in as little as 3-5 seconds. After positioning the device 400, one rescuer may resume manual chest compressions from one side of the patient while the second rescuer prepares the mechanical CPR device 402 for deployment. Power may be activated, the mechanical CPR device 402 may be rotated 90 degrees as shown in FIG. 4D, and, in a coordinated manner, rescuers may position an ACD suction cup-based motor element (or other interface device) over the patient and rapidly couple the arms of the mechanical CPR device 402 to an integrated back plate 406 as shown in FIG. 4E. The arms may slide in a telescoping manner, allowing the user to position the suction cup so that it makes initial contact with the patient, thus setting the height of the mechanical CPR device 402. This process may take about 3-5 seconds. CPR may be initiated. It should be noted that during this implementation process that in some embodiments audio, visual, video, augmented reality, and/or virtual reality based telecommunication between a remotely located trained medical professional and the person on scene helping to deliver HUP CPR may be guided and coordinated.

It should be noted that the HUP CPR devices may serve as a platform for additional CPR devices and aids. For example, an automatic external defibrillator could be attached to the HUD or embodied within it and share the same power source. Electrodes could be provided and attached rapidly to the patient once the patient is place on the HUD. Similarly, ECG monitoring, end tidal CO₂ monitoring, brain sensors, and the like could be co-located on the HUD. In addition, devices that facilitate the cooling of a patient could be co-located on the HUD to facilitate rapid cooling during and after CPR.

It should be further noted that during the performance of CPR the compression rate and depth and force applied to the chest might vary depending upon whether the patient is in the flat horizontal plane or whether the head and thorax are elevated. For example, CPR may be performed with compressions at a rate of 80/min using active compression decompression CPR when flat but at 100 per minute with head and thorax elevation in order to maintain an adequate perfusion pressure to the brain when the head is elevated. Moreover, with head elevation there is better pulmonary circulation so the increase in circulation generated by the higher compression rates will have a beneficial effect on circulation and not “overload” the pulmonary circulation which could happen when the patient is in the flat horizontal plane.

Such systems and methods combine one or more life-saving technologies with elevation of the head or elevation of the head and thorax. One such technology is the automated external defibrillator or AED AEDs were first introduced about 30 years ago in public locations where there is a higher incidence of cardiac arrest, such as airports, sports stadiums, food markets, and office buildings. They can be applied by professional or lay rescuers. Typically, AEDs provide audio and/or visual instructions regarding when and how to perform CPR and when a defibrillation shock should be delivered. AEDs have been shown to increase survival rates when applied rapidly and when CPR is performed. Despite the use of AEDs, however, most patients treated with AEDs never wake up after a cardiac arrest. The reasons are many but high on the list is the limited flow to brain and heart achieved with standard CPR. However, the combination of standard CPR and elevation of the head and heart provides more blood flow and offer the opportunity to improve the likelihood of a successful outcome after cardiac arrest and AED use. In addition, the combination of CPR with addition circulatory enhancers, such as devices that regulated intrathoracic pressure (e.g. and impedance threshold device), and elevation of the head and thorax further improve blood flow to the heart and brain during CPR.

The AED may include electrode pads that may be applied to the bare chest of the patient. In some embodiments, an AED may be configured to autonomously analyze a patient's condition. In such embodiments, when operated, the electrode pads may allow the AED to examine the electrical output from the heart and determine if the patient is in a shockable rhythm (either ventricular fibrillation or ventricular tachycardia). If the device determines that a shock is warranted, the AED will use a battery to charge an internal capacitor and, when charged, delivers a shock to the patient's chest. In non-autonomous modes, an operator of the AED may interact with the AED (such as by interacting with a user interface of the AED) to trigger the delivery of a shock. In some embodiments, after the first shock is delivered an AED may analyze the patient and either instruct CPR to be performed, or prepare to administer another shock. In some embodiments, the strength, duration, and/or sequence of shocks may be adjusted, either manually or automatically based on the sensed heart rhythm of the patient. The shocks from an AED are typically between about 100-400 joules, with ranges of about 120-200 joules being more common. For example, newer AEDs often use biphasic algorithms that administer two sequential lower-energy shocks of 120-200 joules, with each shock moving in an opposite polarity between the pads. This lower-energy waveform may be more effective based on some clinical tests, as well as offering a reduced rate of complications and reduced recovery time. In some embodiments, the AED may provide audio and/or visual feedback to a rescuer regarding a quality of chest compressions being administered.

Oftentimes, HUP CPR devices, now known or developed in the future (including those described herein) may be provided in hardware that is readily portable and may be carried by a single user and/or a single hand. HUP CPR devices may include those described herein, as well as those described in U.S. application Ser. Nos. 16/201,339, 16/058,851, 15/160,492, U.S. Pat. Nos. 10,667,987, 10,406,069, 10,406,068, 10,350,137, 9,801,782, 9,750,661, 9,707,152, 10,092,481, and 10,245,209, the complete disclosures of which have previously been incorporated by reference for all intents and purposes. As described above, these devices may provide various functionality, such as a mechanism to compress the chest, actively decompress the chest, regulate intrathoracic pressure, elevate the head and thorax in a controlled and clinically beneficial manner, monitor the patient for electrical and/or other physiological activities, provide positive pressure ventilations, and/or provide electrical defibrillation in a controlled and regulated manner. Such HUP CPR devices may be stored anywhere, such as in an office or retail building a coffee shop, restaurant, grocery store, etc., on or in a storage area of a car or truck, and/or other location. The portable devices may be hung and/or otherwise mounted on a wall, positioned within a shelf or cabinet, and/or otherwise positioned for easy access by nearby individuals. While such a device, hanging on the wall for example, is a benefit, it is only of clinical use if the device is readily accessible and available for use in treating a patient in a timely manner. Therefore, embodiments of the present invention include a number of features that enable HUP CPR devices and/or other CPR assist devices to be deployed as quickly as possible. Embodiments of HUP CPR devices may provide guidance to lay rescuers and professional rescuers alike such that the general public and professional rescuers are made aware 1) that a cardiac arrest is in progress 2) the cardiac arrest is occurring at a certain location, and 3) how to operate the HUP CPR device to treat the patient. To do this, the HUP CPR devices described herein may receive include a wireless communications interface that may receive a signal from an emergency medical services (EMS) system (or other entity) alerts the HUP CPR device that a cardiac arrest patient has been reported and that provides the location of the cardiac arrest patient to the HUP CPR device. In response to the signal, the HUP CPR device may activate one or more audio and/or visual output devices to produce an alert to nearby persons, who may be trained EMS or medical personnel and/or untrained laypersons. The alert may instruct the nearby persons to pick up or otherwise transport the portable HUP CPR device to the location of the cardiac arrest patient. In some embodiments, prior to receiving the signal, the HUP CPR device may be in a low power mode in which the only active functionality is listening for the signal. This may help preserve battery life and/or reduce power consumption of the HUP CPR device. The low power mode may be deactivated and a full power mode may be initiated by 1) moving the HUP CPR device, 2) receiving the signal from the EMS system, and/or 3) by actuation of a power button of the HUP CPR device. In some embodiments, the mounting mechanism may be part of and/or otherwise coupled with a charging device such that the HUP CPR device remains connected to power and is fully charged/charging when not in use and stored or otherwise engaged with the mounting mechanism.

In addition, some embodiments of HUP CPR devices may include the ability to provide instructions to the lay rescuer related to how to use the HUP CPR device efficiently and rapidly in order to ensure that the resuscitation efforts may be undertaken as rapidly and safely as possible, even before the arrival of trained medical personnel. For example, in some embodiments, the HUP CPR device may include prerecorded audio and/or visual instructions that guide lay users in how to position the patient on the device and how to operate the HUP CPR device. In some embodiments, the HUP CPR devices described herein may include a communications interface that is configured to establish a communications link between a user of the device and a medical professional that is located remotely from the HUP CPR device, such as in a medical facility or emergency dispatch center. The communications link enables the medical professional to talk the user through the use of the HUP CPR device (such as proper positioning of the individual and/or operation of the HUP CPR device), to answer any questions from the user, and/or assist with any other issues or complications that may arise. In some embodiments, the communications link may be established by a user pressing a button or otherwise actively interacting with an interface of the HUP CPR device to request remote assistance. In other embodiments, the HUP CPR device may automatically establish the communications link upon being activated and/or moved from its storage position. For example, once a power button is activated, the HUP CPR device may establish the communications link. In other embodiments, one or more sensors may be utilized to automatically establish the communications link. For example, in some embodiments a sensor may be coupled with a mounting mechanism such that when the HUP CPR device is removed from a wall or other storage mechanism, the HUP CPR device may automatically establish the communications link. In other embodiments, the HUP CPR device may include an accelerometer, global positioning satellite (GPS) sensor, and/or other motion sensor. Once the location guidance alert has been activated, the HUP CPR device may detect when a user has begun moving the device based on data from the motion sensor and then automatically establish the communications link.

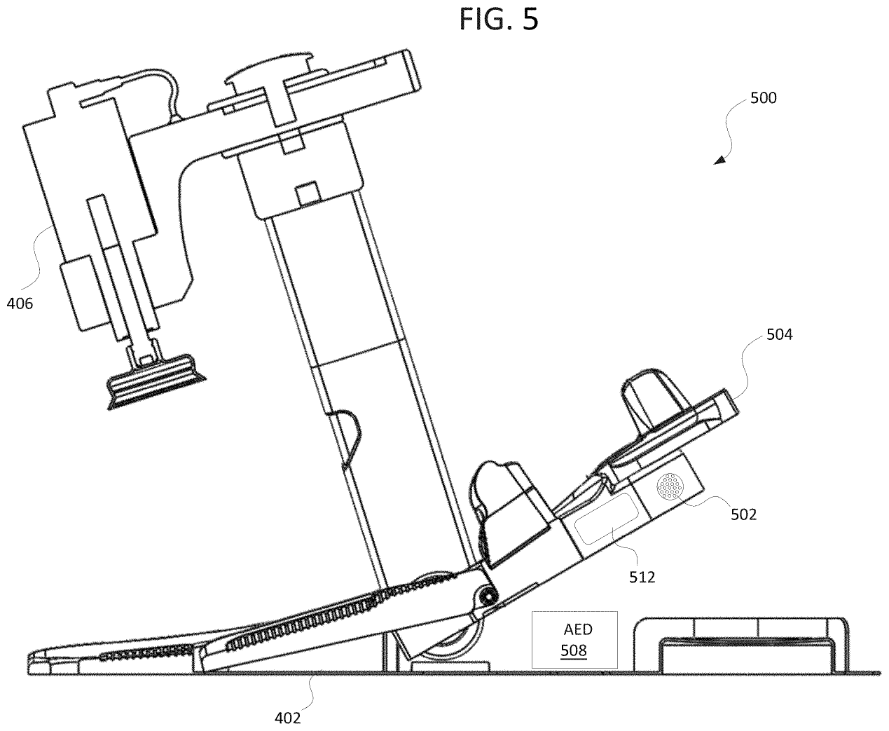

FIG. 5 illustrates a HUP CPR device 500 that may include location-guidance capabilities. HUP CPR device 500 may be similar to the HUP CPR devices described herein and may include any of the features described in accordance with such HUP CPR devices. For example, the HUP CPR device 500 may include a base 502 that is coupled with a support surface 504 that is configured to support and elevate a patient's head and thorax relative the lower body. Oftentimes, the support surface 504 may be positioned only under the patient's upper body, while the lower body rests upon the ground or other support surface. A chest compression device 506 may be coupled with the support surface 504 and/or base 502. The chest compression device 506 may be configured to compress the patient's chest. In some embodiments, the chest compression device 506 may be configured to actively decompress the patient's chest in between each compression. In some embodiments, the HUP CPR device 500 may also include at least one sensor (not shown) that is configured to sense electrical activity for the individual and a defibrillator 508 that is configured to deliver one or more shocks to the individual based upon the interpretation of the sensed electrical activity. The HUP CPR device 500 may also include an intrathoracic pressure regulation device, such as an ITD, that is configured to interface with an airway of the individual.

The HUP CPR device 500 also includes a wireless communications interface (not shown) that is configured to facilitate communication with an EMS system and/or remote medical expert. The wireless interface may communicate using WiFi, 3G, 4G, 5G LTE, and/or other wireless communications protocols. The HUP CPR device 500 also includes a signaling interface having one or more alerting devices, such as a speaker 510, lights, and/or a display screen 512. When signals to move and/or use the HUP CPR device 500 are received from an EMS system, the speaker 510 and/or display screen 512 may produce auditory and/or visual alerts that instruct nearby persons to move the HUP CPR device 500 to the location of the patient. For example, the speaker 510 may emit a beep and/or other noise to get a nearby person's attention while the display screen 512 presents a map and/or instructions on where to take the HUP CPR device. The map and/or instructions may detail a layout of surroundings and/or route between a location of the HUP CPR device 500 and the cardiac arrest patient. The map and/or instructions may be provided to the HUP CPR device 500 by the EMS system and/or may be generated by a processor and mapping application of the HUP CPR device 500 based on a location of the cardiac arrest patient provided by the EMS system. In some embodiments, voice instructions and/or a live transmission from EMS personnel may be emitted from the speaker 510 to instruct users to take the HUP CPR device 500 to the patient, along with audio instructions on where the patient is and/or how to reach the patient. The speaker 510 and/or display screen 512 may also be usable to provide the rescuer with prerecorded and/or live audio and/or video instructions related to the use of the HUP CPR device 500. For example, in some embodiments, the wireless communications interface may establish a live communications link with a remotely located medical expert that can provide voice and/or video guidance to the lay rescuer to help properly position a patient on the HUP CPR device 500 and/or to operate the HUP CPR device 500. The live communications link may enable one-way audio and/or video communications from the medical expert to the rescuer and/or bi-directional communication that enables the medical expert and rescuer to communicate with one another. In embodiments that enable bi-directional communications, the HUP CPR device 500 may include one or more microphones, cameras, and/or other communications input devices to facilitate communication between the rescuer and medical expert. In some embodiments, a movable camera may be attached or included with the HUP CPR device 500 that enables rescuers to capture video of the patient and/or resuscitation effort such that a remote medical expert may observe and provide feedback to the rescuer.

In some embodiments, the HUP CPR device 500 may include a location module. The location module may include one or more location sensors, such as GPS sensors. In some embodiments, the location module may determine a location of the HUP CPR device 500 by using triangulation with one or more wireless signals, such as cellular communications signals. The location of the HUP CPR device 500 may be communicated to the EMS system to ensure that the EMS system has a current location of the HUP CPR device 500. This helps the EMS system identify a closest HUP CPR device 500 to a patient and/or produce more accurate navigation instructions to rescuers who need to move the HUP CPR device 500 to the patient. In some embodiments, the HUP CPR device 500 may also include one or more sensors that operate to automatically establish the communications link upon the HUP CPR device 500 receiving the signal from the EMS system and being moved from its storage position. For example, in some embodiments a sensor may be coupled with a mounting mechanism that is used to store the HUP CPR device 500 when not in use. When HUP CPR device 500 is moved from the storage location, the sensor may detect the disengagement of the HUP CPR device from the mounting mechanism and may cause the HUP CPR device 500 to automatically establish the communications link. In other embodiments, the HUP CPR device 500 may include an accelerometer, GPS sensor, and/or other motion sensor that may alert a controller of the HUP CPR device 500 that the HUP CPR device 500 is moving. Movement of the HUP CPR device 500 may cause the communications link to be established automatically.

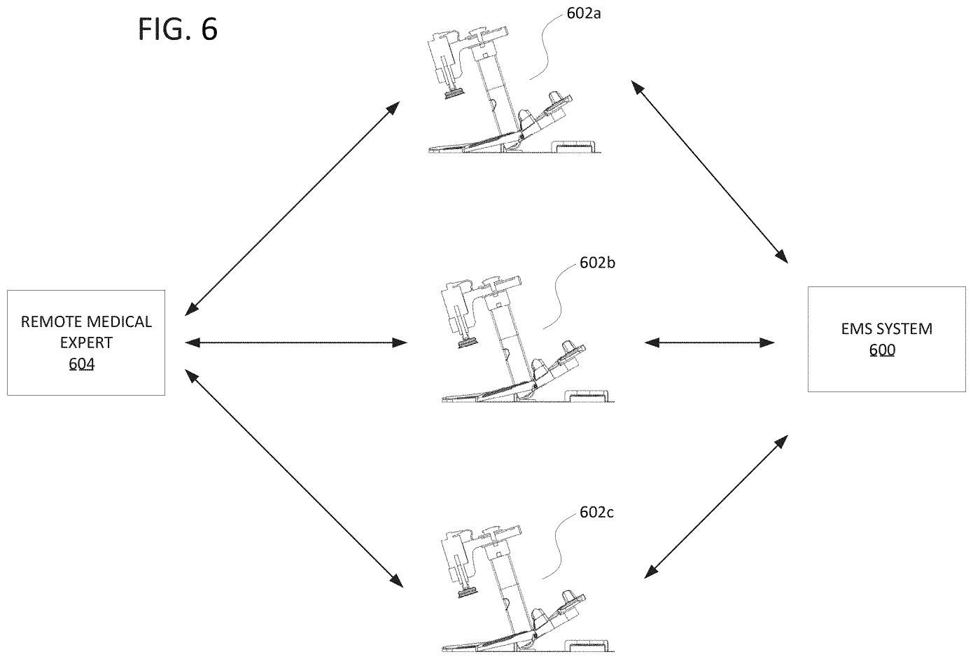

FIG. 6 illustrates a system for providing location guidance to one or more HUP CPR devices. The system may include an EMS system 600. The EMS system 600 may be a computing device (or software executed by a computing device) operated directly by an EMS operator (or other entity) and/or may be a remote computing device (such as a server) that is in communication with a computer of one or more EMS operators. The EMS system 600 may be in communication with a database that stores data about known HUP CPR devices 602a, 602b, 602c and their locations and/or may be in direct communication with the HUP CPR devices 602a, 602b, 602c so as to receive current location information from each of the HUP CPR devices 602a, 602b, 602c. When a call for help is made by a lay rescuer calling 911, the call may be immediately dispatched to EMS personnel that will direct them to the scene. The EMS system 600 (via either a call taker or machine that receives and interprets the call) may simultaneously (or nearly simultaneously) identify the closest HUP CPR device 602a, 602b, 602c to the location of the cardiac arrest patient. For example, the EMS operator may enter a location of the cardiac arrest patient based on the content of the phone call. The EMS system 600 (either automatically or under the direction of the EMS operator) may identify a nearest HUP CPR device, here HUP CPR device 602b, based on 1) the location of the cardiac arrest patient and 2) the location information in the database and/or location information provided from HUP CPR devices 602a, 602b, 602c in communication with the EMS system 600. A signal may be sent out from the EMS system 600 to the nearest HUP CPR device 602b that causes the HUP CPR device 602 to begin notifying the public by beeping and/or producing or some other audio signal, producing a visual signal, and/or by emitting a pre-recorded message that informs nearby persons that there is a cardiac arrest at a particular location relative to the HUP CPR device. The signal may include an audio feed from a live dispatcher that may communicate information (such as location information) associated with the patient. In some embodiments, once the HUP CPR device 602b is activated, the HUP CPR device 602b may send a signal back to the EMS system 600 when the HUP CPR device 602b is removed from a storage location and may initiate communication between the person carrying this portable HUP CPR device 602b and a remote medical expert 604. In this manner rapid communication can be established to better guide the resuscitation effort. The HUP CPR device 602b may be activated by the lay rescuer in a certain order that will include placing part of the HUP CPR device 602b under the patient's head and thorax and beginning CPR using the HUP CPR device 602b while emergency personnel are dispatched to the location.

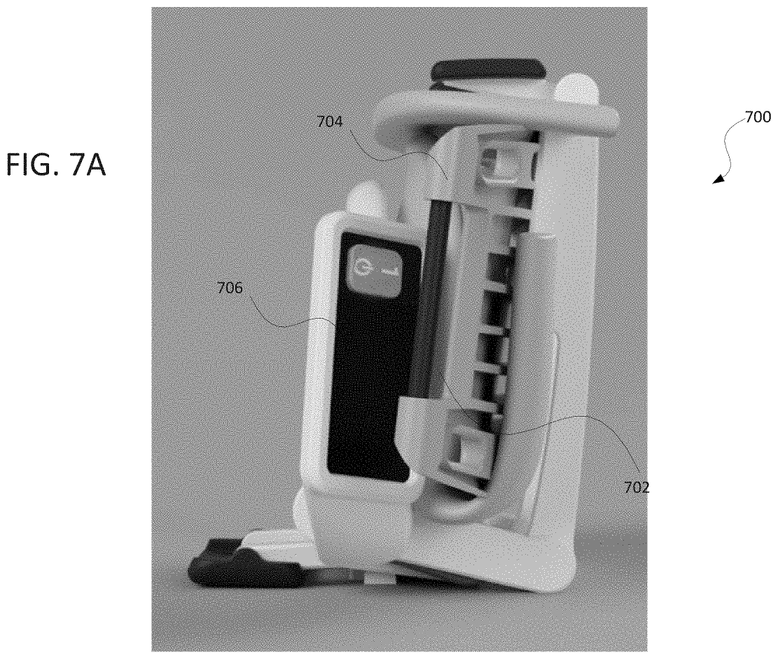

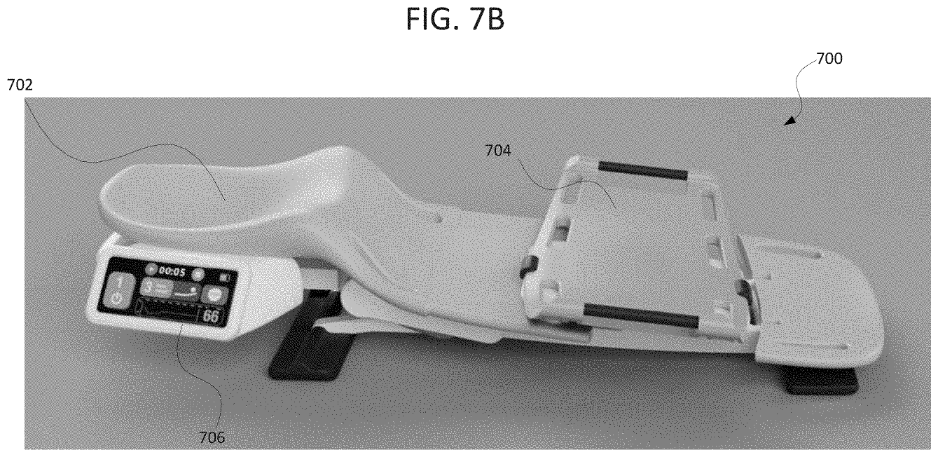

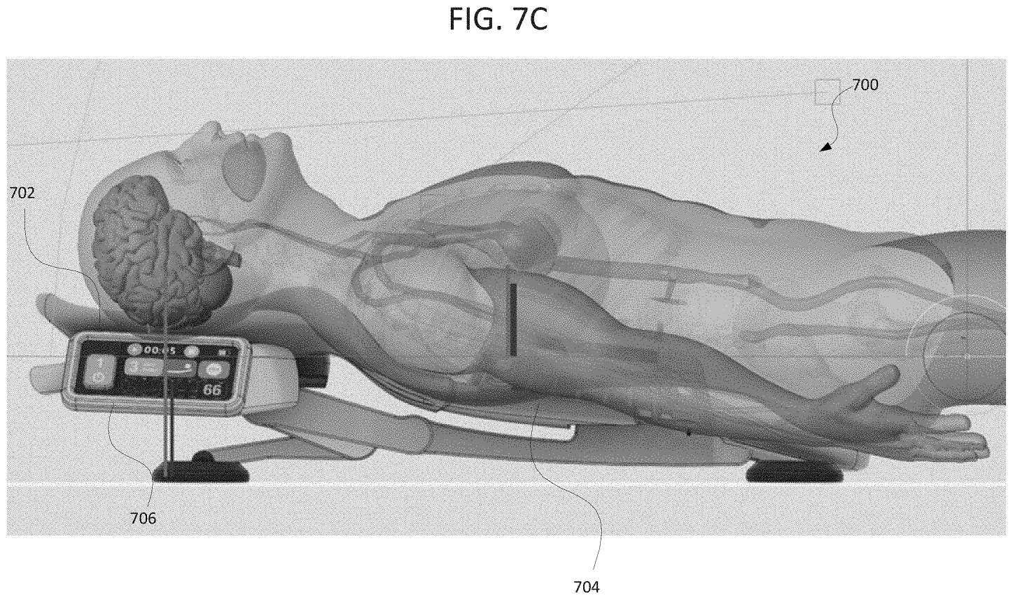

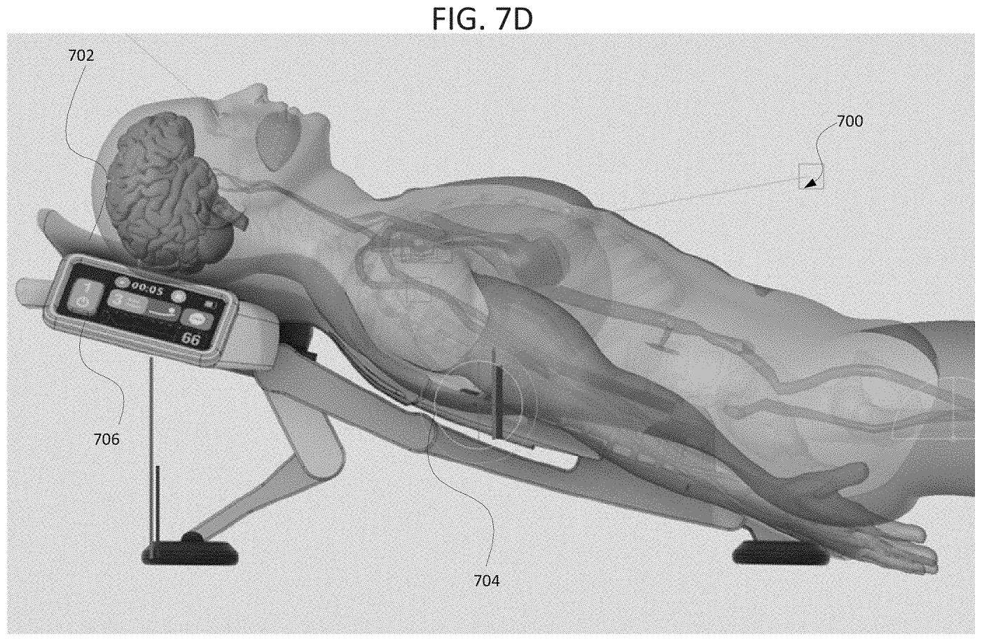

FIGS. 7A-7D illustrate an alternative design for a HUP CPR device 700. HUP CPR device 700 may be similar to the other devices described herein and may include a predefined head receiving portion 702 that may support and elevate a patient's head. The device 700 may also include a thorax-receiving portion 704 that is configured to support and elevate a patient's chest. The device 700 may also include a control panel 706 that may be used to control and monitor the elevation of the patient, monitor one or more physiological sensors interfaced with the patient, and/or control one or more other devices, such as a chest compression device and/or AED. In FIG. 7A the device 700 is compact and folded for easy transport and/or storage, while in FIG. 7B the device 700 is shown unfolded. In FIG. 7C, the device 700 is positioned underneath a patient in the lowest position, with the patient's head supported in the predefined head-supporting portion 702 and the patient's chest supported by the predefined thoracic support portion 704. In FIG. 7D, the device 700 is in the highest position. The control panel 706 can be used for multiple purposes. For example, the control panel 706 can serve as a flashing light, a phone, a GPS system, and/or the touch screen can be used to guide and monitor CPR and the position of the patient and the function of an AED. As shown in FIGS. 7C and 7C, the control panel 706 is shown in the monitor mode, with a display of regional cerebral oximetry. While not shown, it will be appreciated that device 700 may include and/or be interfaced with one or more devices, such as a ventilator, ITD, chest compression device, AED, and the like.

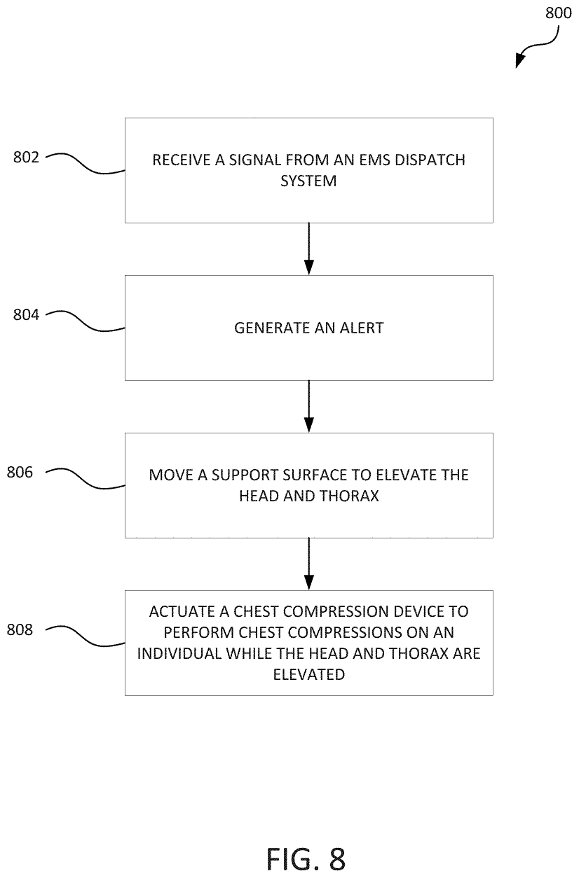

FIG. 8 illustrates a flowchart of a process 800 for operating a portable head up CPR device. Process 800 may utilize any of the HUP CPR devices and/or EMS systems described herein. Process 800 may begin at operation 802 by receiving, by a portable HUP CPR device, a signal from an EMS dispatch system. The signal may indicate a location of an individual suffering from cardiac arrest. In response to the signal, the HUP CPR device may generate an alert containing instructions to move the portable HUP CPR device to the location of the individual in response to receiving the signal at operation 804. The alert may include an electronic alert, an auditory alert, and/or a visual alert. The instructions may be audible and/or visual. For example, a display screen of the HUP CPR device may provide a map and/or instructions to get to the patient. A speaker may emit pre-recorded and/or live audio instructions on how to reach the patient.

In some embodiments, the process 800 may include detecting, by the portable HUP CPR device, that the portable head up CPR device has been moved from a storage location. This may cause the HUP CPR device to initiate audio and/or video instructions that inform a user how to operate the portable HUP CPR device. The detection of movement may involve detecting, using a sensor, that the portable HUP CPR device has been disengaged from a mounting mechanism. The detection of movement may involve detecting movement of the portable head up CPR device using one or more motion sensors. The initiation of audio and/or video instructions may include establishing a live communications link between the portable head up CPR device and a medical service provider, which may enable the medical service provider to guide a rescuer on proper resuscitation techniques. In some embodiments, the HUP CPR device may switch from a low power mode to a normal operational mode upon receiving the signal from the EMS system and/or upon detecting movement from a storage location. In the low power mode, only essential systems, such as the ability to receive the initial signal from the EMS system and/or movement sensors may be active, which enables the HUP CPR device to conserve power. Upon switching to the normal operational mode, all functionality of the HUP CPR device, including the communications interface, elevation functions, chest compression functions, and the like, may be activated.

Once the HUP CPR device has been moved to the patient, the patient may be positioned on the HUP CPR device and treatment may begin. For example, at operation 806, a support surface of the portable HUP CPR device may be moved to elevate a head and thorax of an individual. At operation 808, a chest compression device may be actuated to perform chest compressions on the individual while the head and the thorax of the individual are elevated. The chest compression device may be part of and/or coupled with the HUP CPR device, and may be configured to assist with manual and/or automated delivery of chest compressions and/or active decompressions. The treatment of the patient may be guided by prerecorded and/or live audio and/or video instructions delivered by speakers and/or a display screen of the HUP CPR device. In some embodiments, the communications link may be used by the rescuer and medical expert to ensure that proper treatment is provided to the patient.

The methods, systems, and devices discussed above are examples. Various configurations may omit, substitute, or add various method steps or procedures, or system components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations may be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Furthermore, the example examples described herein may be implemented as logical operations in a computing device in a networked computing system environment. The logical operations may be implemented as: (i) a sequence of computer implemented instructions, steps, or program modules running on a computing device; and (ii) interconnected logic or hardware modules running within a computing device.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A portable head up CPR device comprising:
an automated chest compression-decompression device;
a support structure configured to elevate a head and thorax of an individual;
a wireless network interface;
a signaling interface;
at least one processor; and
a memory having instructions thereon that, when executed by the at least one processor, cause the at least one processor to:
receive a signal from an EMS dispatch system via the wireless network interface, the signal comprising a location of the individual in distress; and
generate an alert via the signaling interface, the alert being selected from a group comprising an electronic alert, an auditory alert, and a visual alert, wherein the alert comprises instructions to move the portable head up CPR device to the location of the individual in response to receiving the signal.

2. The portable head up CPR device of claim 1, wherein the instructions, when executed, further cause the at least one processor to:
activate a lift mechanism of the portable head up CPR device to move the support structure to elevate the head and thorax of the individual.

3. The portable head up CPR device of claim 1, further comprising:
at least one sensor that is configured to sense electrical activity for the individual; and
a defibrillator that is configured to deliver one or more shocks to the individual based upon the interpretation of the sensed electrical activity.

4. The portable head up CPR device of claim 1, wherein the instructions, when executed, further cause the at least one processor to:
cause the chest compression device to deliver chest compressions to the individual.

5. The portable head up CPR device of claim 1, wherein:
the alert further comprises instructions for using the portable head up CPR device to treat the individual.

6. The portable head up CPR device of claim 1, further comprising:
a communications interface that is configured to establish a communications link between a user of the portable head up CPR device and a remotely located medical expert.

7. The portable head up CPR device of claim 1, wherein the instructions, when executed, further cause the at least one processor to:
determine a location of the portable head up CPR device; and
communicate the location of the portable head up CPR device to the EMS dispatch system.

8. An emergency dispatch system, comprising:
a communications interface;
at least one processor; and
a memory having instructions stored thereon that, when executed by the at least one processor cause the at least one processor to:
receive a first signal from an emergency medical system, the first signal indicating that an individual at a particular location is suffering from cardiac arrest;
locate a portable head up CPR device that is most proximate to the particular location; and
send, using the communications interface, a second signal to the portable head up CPR device, the second signal causing the portable head up CPR device to produce one or both of an auditory alert and a visual alert that instructs a nearby user to move the portable head up CPR device to the particular location.

9. The emergency dispatch system of claim 8, wherein the instructions, when executed, cause the at least one processor to:
establish a communications link between the portable head up CPR device and a medical service provider.

10. The emergency dispatch system of claim 8, wherein:
the communications link supports one or both of telecommunication and visual communication.

11. The emergency dispatch system of claim 8, wherein:
the second signal further causes the portable head up CPR device to switch from a low power mode to a normal operational mode.

12. The emergency dispatch system of claim 8, wherein:
locating the portable head up CPR device comprises comparing the particular location to a database of known locations of portable head up CPR devices.

13. The emergency dispatch system of claim 8, wherein:
locating the portable head up CPR device comprises receiving a current location of a number of portable head up CPR devices and comparing the particular location to the current locations of the number of portable head up CPR devices.

14. The emergency dispatch system of claim 8, wherein:
the emergency dispatch system is remotely located from the emergency medical system; and
the first signal is received via the communications interface.

15. A method of operating a portable head up CPR device, comprising:
receiving, by the portable head up CPR device, a signal from an EMS dispatch system, the signal comprising a location of an individual suffering from cardiac arrest;
generating an alert, by the portable head up CPR device, the alert being selected from a group comprising an electronic alert, an auditory alert, and a visual alert, wherein the alert comprises instructions to move the portable head up CPR system to the location of the individual in response to receiving the signal;
moving a support surface of the portable head up CPR device to elevate a head and thorax of an individual; and
actuating a chest compression device to perform chest compressions on the individual while the head and the thorax of the individual are elevated.

16. The method of operating a portable head up CPR device of claim 15, further comprising:
detecting, by the portable head up CPR device, that the portable head up CPR device has been moved from a storage location; and
initiating one or both of audio or video instructions that inform a user how to operate the portable head up CPR device upon detecting that the portable head up CPR device has been moved from the storage location.

17. The method of operating a portable head up CPR device of claim 16, wherein:
detecting that the portable head up CPR device has been moved from the storage location comprises detecting, using a sensor, that the portable head up CPR device has been disengaged from a mounting mechanism.

18. The method of operating a portable head up CPR device of claim 16, wherein:
detecting that the portable head up CPR device has been moved from the storage location comprises detecting movement of the portable head up CPR device using one or more motion sensors.

19. The method of operating a portable head up CPR device of claim 16, wherein:
initiating one or both of audio or video instructions comprises establishing a live communications link between the portable head up CPR device and a medical service provider.

20. The method of operating a portable head up CPR device of claim 15, further comprising:
switching from a low power mode to a normal operational mode upon receiving the signal.
